(19) United States
(12) Patent Application Publication
(10) Pub. No.: US 2007/0124081 A1
(43) Pub. Date: May 31, 2007

(54) Biological information processing apparatus, biological information processing method and biological information processing program

(76) Inventors: Tamotsu Noguchi, Tokyo (JP); Shuichi Hirose, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/598,600

(22) Filed: Nov. 14, 2006

(30) Foreign Application Priority Data
Nov. 30, 2005 (JP) 2005-345609

(51) Int. Cl. G06F 19/00

(52) U.S. Cl. 702/19

(57) ABSTRACT

A biological information processing apparatus predicts a disordered region in a polypeptide. The biological information processing apparatus comprises a prediction target data acquisition unit which acquires amino acid sequence data of a polypeptide of the prediction target; a window level prediction unit which predicts a disordered region at the level of a window sequence with a predetermined window size contained in the amino acid sequence data of the prediction target; and an amino acid residue level prediction unit which predicts a disordered region at the level of each amino acid residue contained in the amino acid sequence data of the prediction target based on the prediction result by the window level prediction unit. With the use of the biological information processing apparatus, the reliability of prediction is improved.

### BACKGROUND OF THE INVENTION

1. Field of the Invention

The present invention relates to a biological information (bio-information) processing apparatus, a biological information processing method and a biological information processing program for predicting a disordered region in a polypeptide.

2. Background

The function of a protein is determined by its structure, therefore, prediction of tertiary structure is a very important issue for elucidating the function of protein. In recent years, while many tertiary structures have been determined by an X-ray analysis or NMR, it became known that a protein with a partially unfolded regions or wholly unstructured exists in a number of species. From this finding, it has come to be considered that a region which lacks well-defined three dimensional structure (disordered region) has some functional role and is evolutionary conserved. Accordingly, prediction of the disordered region of a protein has attracted attention.

Between a disordered region and an ordered region, there is an obvious difference in various characteristics such as an amino acid composition. Therefore, in many related studies, differences in characteristics between a disordered region and an ordered region in data acquired in advance are examined and learned, and prediction is carried out by various methods.

For example, the following documents 1 and 2 disclose related programs for predicting a disordered region present in a protein from an amino acid sequence.

Document 1: Jones, D. T. & Ward, J. J. “Prediction of disordered regions in proteins from position specific score Matrices” Proteins: Strut. Funct. Genet. (2003), 53, 573-578

Document 2: Ward, J. J., Sodhi, J. S., McGuffin, L. J., Buxton, B. F., Jones, D. T. “Prediction and Functional Analysis of Native Disorder in Proteins from the Three Kingdoms of Life” J. Mol. Biol. (2004) 337, 635-645

The programs described in these documents have two steps. The first step is to predict a disordered region at an amino acid residue level by constructing a profile of input values composed of amino acid sequences by PSI-BLAST and classifying the profile with the SVM (support vector machine).

The second step is to predict a disordered region at an amino acid residue level again by further analyzing the thus obtained prediction result of disordered region at an amino acid residue level with the neural network. Then, the prediction result obtained in this second step is output as a prediction result of a disordered region.

PSI-BLAST is the abbreviation of Position Specific Iterative BLAST. In PSI-BLAST, a multiple alignment (alignment of a plurality of sequences) is automatically constructed from the first search result. This is used as a profile (or position specific scoring matrix (PSSM)), and a search of database is done again. In the above-mentioned documents, the above-mentioned multiple alignment function possessed by PSI-BLAST is employed. At this time, a plurality of window sequences are listed in the multiple alignment. The length of each window sequence is about 15 residues.

The related art described in the above-mentioned documents has room for improvement in the following points.

In a program of the related art, a window sequence with about 15 amino acid residues for which a profile has been constructed using PSI-BLAST is acquired. A plurality of window sequences are aligned in such a manner that they are shifted by one residue while overlapping with one another, thus a window sequence group is constructed. The window sequences are input into the support vector machine (SVM) and the neural network and classified. Then, the program of the related art determines whether or not one amino acid residue in the center of each window sequence is contained in a disordered region by using the classification result.

In the above process, in the related art, each amino acid residue in an amino acid sequence is allowed to correspond one-to-one to a window sequence containing the amino acid residue in the center of the segment. Then, determination of each amino acid residue is carried out by using one corresponding window sequence. These determination results are aligned and a disordered region is specified.

In general, it is considered that whether or not each amino acid residue is contained in a disordered region is determined by comprehensively taking into account the relation with a number of neighboring amino acid residues and the like in addition to the type of the amino acid residue under natural conditions such as in vivo.

In spite of this, in the related art, determination of each amino acid residue is carried out only from the classification results of window sequences with a length of about 15 residues containing the amino acid residue in the “center” of the segment. In the related art, the relation between the respective amino acid residues when they are located at a position “outside the center” of the window sequence and the other amino acid residues is not taken into account as an object of the evaluation. Consequently, the relation between the respective amino acid residues and a number of neighboring amino acid residues and the like are not comprehensively incorporated as an object of the evaluation. Accordingly, there is room for improvement in this point in terms of reliability of the prediction results.

### SUMMARY OF THE INVENTION

The present invention has been made in view of the above-mentioned circumstances, and an object thereof is to predict a disordered region in a polypeptide with high reliability.

One aspect of the present invention is a biological information processing apparatus for predicting a disordered region in a polypeptide. This apparatus comprises a prediction target data acquisition unit which acquires amino acid sequence data of a polypeptide of a prediction target; a window level prediction unit which performs prediction of a disordered region at the level of a window sequence with a predetermined window size contained in the amino acid sequence data of the prediction target; and an amino acid residue level prediction unit which performs prediction of a disordered region at the level of each amino acid residue contained in the amino acid sequence data of the prediction target based on the prediction result by the window level prediction unit. The window level prediction unit acquires a window level disorder index value indicating the probability that each window sequence belongs to a disordered region by comparing each of the window sequences which are shifted by a predetermined number of residues with a known window sequence group whose disorder correspondence is known (that is, whether or not each window sequence of the group corresponds or belongs to the disordered region is known). The amino acid residue level prediction unit predicts whether or not a focused residue is contained in a disordered region by setting each amino acid residue contained in the amino acid sequence data as the focused residue of the prediction target, acquiring distribution characteristic data of a plurality of window level disorder index values acquired respectively from the plurality of window sequences which contain the focused residue and are shifted by the predetermined number of residues, and comparing the distribution characteristic data related to the focused residue with a distribution characteristic data group acquired from the known window sequence group.

The term “disordered region” as used herein means a region in which a tertiary structure is lacking in a protein (a specific tertiary structure is not formed).

In the invention, whether or not one focused amino acid residue (focused residue) is contained in a disordered region is predicted based on the distribution characteristic data of window level disorder index values acquired from the window sequence group composed of a plurality of window sequences which contain the focused residue and overlap with one another and are shifted by a predetermined number of residues.

Accordingly, in the invention, with respect to one focused residue, not only the case where the focused residue is located in the center of a window sequence, but also the case where the focused residue is located at a position outside the center of a window sequence can be taken into account.

In this way, in the invention, with respect to one focused residue, whether or not the focused residue is contained in a disordered region can be predicted by comprehensively taking into account the relation between the focused residue and a number of neighboring amino acid residues. Thus, the reliability of prediction result of a disordered region in a polypeptide can be improved.

The above-mentioned biological information processing apparatus is one aspect of the invention. The biological information processing apparatus of the invention may be an arbitrary combination of the above-mentioned constituent elements. Further, a biological information processing method, a biological information processing system, a biological information processing program, a recording medium containing the biological information processing program and the like which are provided with a similar configuration to that of the biological information processing apparatus of the invention are also have a similar working effect.

As described hereafter, other aspects of the invention exist. Thus, this summary of the invention is intended to provide a few aspects of the invention and is not intended to limit the scope of the invention described and claimed herein.

### BRIEF DESCRIPTION OF THE DRAWINGS

The accompanying drawings are incorporated in and constitute a part of this specification. The drawings exemplify certain aspects of the invention and, together with the description, serve to explain some principles of the invention.

FIG. 1 is a functional block diagram showing a general outline of a configuration of a biological information processing apparatus according to an embodiment.

FIG. 2 is a conceptual diagram showing a general outline of a method of predicting a disordered region by a biological information processing apparatus according to an embodiment.

FIG. 3 is another conceptual diagram showing a general outline of a method of predicting a disordered region by a biological information processing apparatus according to an embodiment.

FIG. 4 is a functional block diagram showing a known data acquisition unit, a window level learning unit and an amino acid residue level learning unit in a biological information processing apparatus according to an embodiment.

FIG. 5 is a conceptual diagram showing a general outline of a training set to be used for learning in a biological information processing apparatus according to an embodiment.

FIG. 6 is a conceptual diagram showing a general outline of feature indices extracted in a first step of a biological information processing apparatus according to an embodiment.

FIG. 7 is a conceptual diagram showing a general outline of a support vector machine which is provided in a biological information processing apparatus according to an embodiment.

FIG. 7A is a conceptual diagram showing a general outline of a support vector machine which is provided in a biological information processing apparatus according to an embodiment.

FIG. 8 is a flowchart for illustrating a flow of learning in a biological information processing apparatus according to an embodiment.

FIG. 9 is a functional block diagram showing a prediction target data acquisition unit, a window level prediction unit and an amino acid residue level prediction unit in a biological information processing apparatus according to an embodiment.

FIG. 10 is a conceptual diagram showing a general outline of a prediction method in a biological information processing apparatus according to an embodiment.

FIG. 11 is a conceptual diagram showing a disordered region determination unit in a biological information processing apparatus according to an embodiment.

FIG. 12 is a flowchart for illustrating a flow of prediction in a biological information processing apparatus according to an embodiment.

FIG. 13 is a conceptual diagram for illustrating a method of deriving feature indices (magnitude of charge and hydrophobicity).

FIG. 14 is a conceptual diagram for illustrating a method of deriving a feature index (sequence complexity).

FIG. 15 is a conceptual diagram for illustrating a method of deriving a feature index (charge cluster).

FIG. 16 is a conceptual diagram for illustrating a method of deriving a feature index (amino acid composition 1).

FIG. 17 is a conceptual diagram for illustrating a method of deriving a feature index (amino acid composition 2).

FIG. 18 is a conceptual diagram for illustrating a method of deriving a feature index (prediction of α-helix).

FIG. 19 is a conceptual diagram for illustrating a method of deriving a feature index (prediction of β-sheet).

FIG. 20 is a conceptual diagram for illustrating a method of deriving a feature index (hydrophobic cluster).

FIG. 21 is a conceptual diagram for illustrating a method of deriving a feature index (contact number).

FIG. 22 is a conceptual diagram for illustrating amino acid indices (hydrophobic index, amino acid occurrence frequency in ordered region and amino acid occurrence frequency in disordered region) to be used for deriving feature indices.

FIG. 23 is a conceptual diagram for illustrating amino acid indices (easiness of α-helix formation, easiness of β-sheet formation and contact number) to be used for deriving feature indices.

FIG. 24 is a conceptual diagram for illustrating value ranges within which respective descriptors of feature indices can fall.

### DETAILED DESCRIPTION

The following detailed description refers to the accompanying drawings. Although the description includes exemplary implementations, other implementations are possible and changes may be made to the implementations described without departing from the spirit and scope of the invention. The following detailed description and the accompanying drawings do not limit the invention. Instead, the scope of the invention is defined by the appended claims.

<General Outline of Biological Information Processing Apparatus>

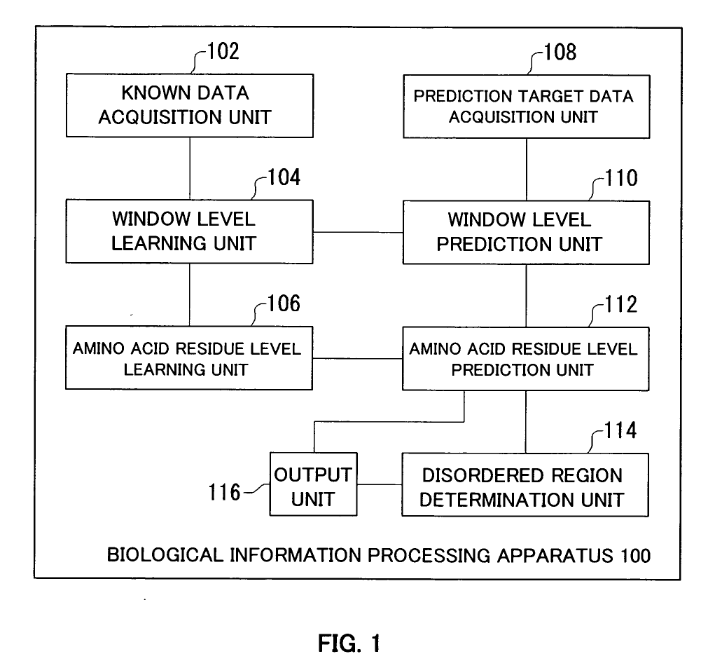

FIG. 1 is a functional block diagram showing a general outline of a configuration of a biological information processing apparatus 100 according to an embodiment. The biological information processing apparatus 100 is an apparatus for predicting a disordered region in a polypeptide. The disordered region means a region which lacks well-defined three dimensional structure in the tertiary structure of a polypeptide. In this embodiment, the polypeptide is a substance including a protein, and the disordered region includes a loop structure.

More specifically, in this embodiment, the biological information processing apparatus 100 is an apparatus for predicting a disordered region as an output value from an input value composed of a sequence of a protein. This apparatus can predict particularly a long disordered region consisting of 30 or more residues. However, of course it is also possible to predict a short disordered region.

The biological information processing apparatus 100 includes a prediction target data acquisition unit 108 which acquires amino acid sequence data of a polypeptide of a prediction target. The amino acid sequence data of a polypeptide of a prediction target can be acquired in an arbitrary form. For example, it can be acquired in a form of one letter standing for one amino acid or in a form of three letters standing for one amino acid. Further, it can be received in a form of a gene sequence in addition to these. In this case, sequence data can be acquired by converting a gene sequence to an amino acid sequence with the use of the universal codon table.

Further, the biological information processing apparatus 100 includes a window level prediction unit 110 which predicts a disordered region at the level of a window sequence with a predetermined window size contained in the amino acid sequence data of a prediction target.

This window level prediction unit 110 compares each of the window sequences which are shifted by a predetermined number of residues with a known window sequence group whose disorder correspondence is known (that is, whether or not each window sequence of the group corresponds or belongs to the disordered region is known).

Then, the window level prediction unit 110 acquires a window level disorder index value indicating the probability that each window sequence belongs to a disordered region by performing comparison as described above. More detailed configuration and function of the window level prediction unit 110 will be described below.

Further, the biological information processing apparatus 100 includes an amino acid residue level prediction unit 112 which predicts a disordered region at the level of each amino acid residue contained in the amino acid sequence data of a prediction target based on the prediction result by the window level prediction unit 110.

This amino acid residue level prediction unit 112 sets each amino acid residue contained in the amino acid sequence data as a focused residue of a prediction target and acquires distribution characteristic data of a plurality of window level disorder index values acquired respectively from the plurality of window sequences which contain the focused residue and are shifted by the predetermined number of residues.

Then, the amino acid residue level prediction unit 112 compares the distribution characteristic data related to the focused residue acquired in this way with a distribution characteristic data group acquired from a known window sequence group. Then, the amino acid residue level prediction unit 112 predicts whether or not the focused residue is contained in a disordered region by performing comparison as described above. More detailed configuration and function of the amino acid residue level prediction unit 112 will be described below.

On the other hand, the biological information processing apparatus 100 includes a known data acquisition unit 102 which acquires known window sequence group data derived from a polypeptide in which a disordered region is known. The known window sequence group data can be acquired in an arbitrary form. For example, it can be acquired in a form of one letter standing for one amino acid or in a form of three letters standing for one amino acid. Further, it can be received in a form of a gene sequence in addition to these. In this case, sequence data can be acquired by converting a gene sequence to an amino acid sequence with the use of the universal codon table.

Further, the biological information processing apparatus 100 includes a window level learning unit 104 which generates a window level disorder classification criterion from the known window sequence group.

This window level learning unit 104 generates a window sequence level classification criterion for predicting a disordered region at the level of a window sequence with a predetermined window size contained in the above-mentioned amino acid sequence data of the prediction target by learning each of the window sequences which are contained in the known window sequence group and are shifted by a predetermined number of residues.

Then, the window level learning unit 104 further acquires a window level disorder index value indicating the probability that each known window sequence belongs to a disordered region with the use of this window sequence level classification criterion. More detailed configuration and function of the window level learning unit 104 will be described below.

Further, the biological information processing apparatus 100 includes an amino acid residue level learning unit 106 which generates an amino acid residue level disorder classification criterion from the window level disorder index value derived from the known window sequence group.

This amino acid residue level learning unit 106 sets each amino acid residue contained in the amino acid sequence data derived from the known window sequence group as a focused residue of a prediction target and acquires distribution characteristic data of a plurality of window level disorder index values acquired respectively from the plurality of window sequences which contain the focused residue and are shifted by a predetermined number of residues.

Then, the amino acid residue level learning unit 106 generates an amino acid residue level classification criterion for predicting a disordered region at the level of an amino acid residue contained in the above-mentioned amino acid sequence data of the prediction target by learning the distribution characteristic data related to the focused residue acquired in this way. More detailed configuration and function of the amino acid residue level learning unit 106 will be described below.

Further, the biological information processing apparatus 100 includes a disordered region determination unit 114 which specifies a disordered region contained in the amino acid sequence data of the prediction target.

This disordered region determination unit 114 specifies a region composed of an amino acid sequence in which amino acid residues predicted to be contained in the disordered region are arranged according to a predetermined rule as a disordered region, based on the prediction result by the amino acid residue level prediction unit 112. More detailed configuration and function of the disordered region determination unit 114 will be described below.

Further, the biological information processing apparatus 100 includes an output unit 116 for outputting the prediction result by the amino acid residue level prediction unit 112 or the determination result by the disordered region determination unit 114.

This output unit 116 can output these results to the outside of the biological information processing apparatus 100 in an arbitrary form. For example, the output unit 116 can output these results through online or by recording them in media, printing them with a printer or the like, or displaying them as an image with a display device or the like.

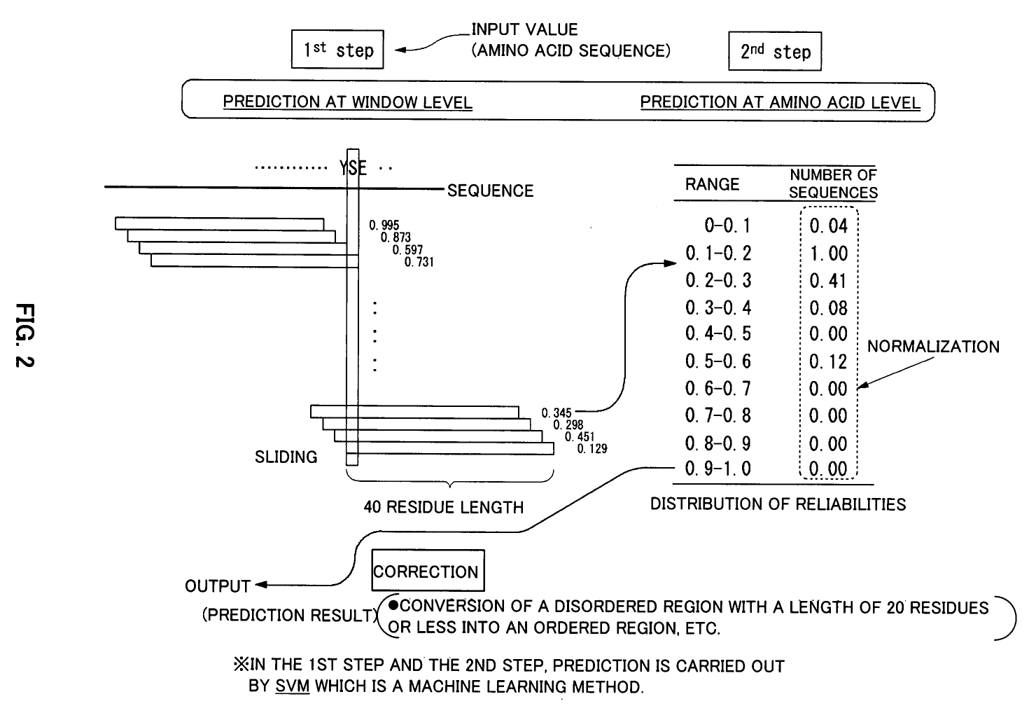

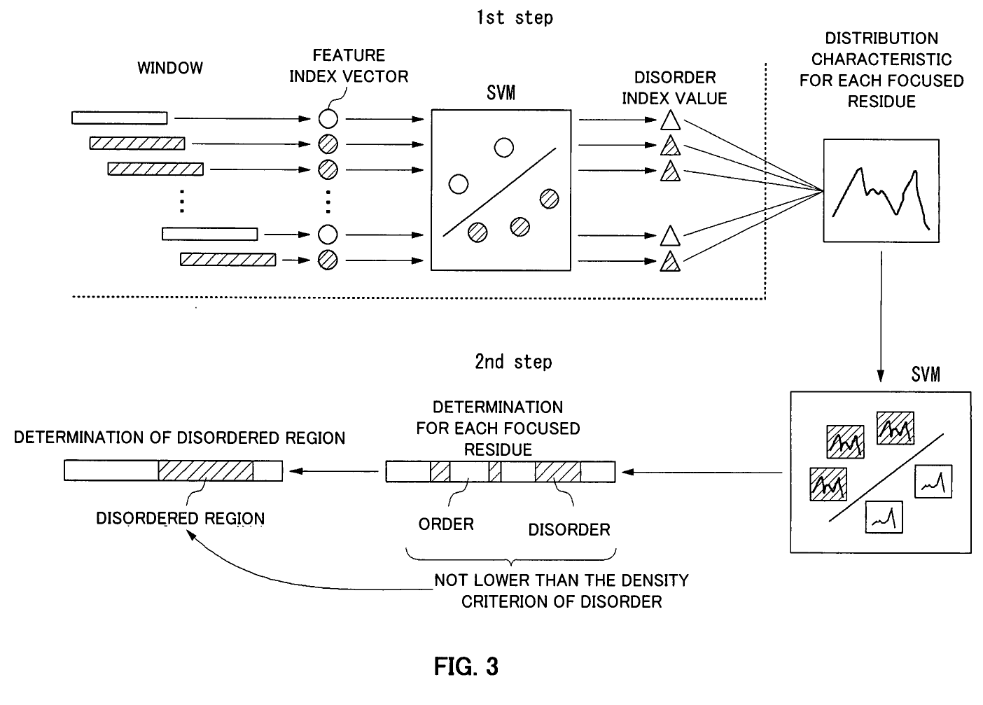

FIGS. 2 and 3 are conceptual diagrams showing a general outline of a method of predicting a disordered region by the biological information processing apparatus 100 according to an embodiment.

The 1st step is a prediction step at the window level. In this step, a plurality of window sequences with a window size of 40 amino acid residues are extracted from amino acid sequences (input values) of a polypeptide in which a disordered region is unknown. Then, the plurality of window sequences constitute an unknown window sequence group in which a plurality of neighboring window sequences are aligned while they are shifted (slid) by one residue with one another. In the neighboring window sequences, the amino acid sequences overlap with one another except for the amino acid residues at both terminals.

Then, from the respective window sequences contained in the unknown window sequence group, a feature index vector is generated as window disorder feature data containing a biological feature index acquired from the amino acid sequence of the window sequence.

This feature index vector is 10-dimensional vector including 10 types of biological feature indices which are presumed to be associated with the probability of forming a disordered region of an amino acid sequence. The 10 types of biological feature indices are magnitude of charge, hydrophobicity, sequence complexity, prediction value of charge cluster, correlation between known ordered region and amino acid composition, correlation between known disordered region and amino acid composition, prediction value of α-helix, prediction value of β-sheet, prediction value of hydrophobic cluster and contact number.

Further, from the feature index vector, a window level disorder index value is acquired. The window level disorder index value is an index value indicating the probability that each window sequence belongs to a disordered region. Here, in order to acquire the window level disorder index value, a support vector machine (SVM) having a window level disorder classification criterion as a separation plane is used.

The support vector machine is one of the means of pattern recognition constituting a pattern discriminator for two classes with the use of linear threshold elements. In particular, the support vector machine has been extended so as to constitute a nonlinear discrimination function by using a method called kernel trick. It is considered that the support vector machine is one of the learning models having the most excellent recognition performance among the techniques known at present.

Here, the above-mentioned window level disorder classification criterion is acquired with a support vector machine by using previously known data. In this case, a plurality of window sequences with a window size of 40 amino acid residues are extracted from a polypeptide in which a disordered region is known in the same manner, and a known window sequence group in which a plurality of neighboring window sequences are aligned while they are shifted by one residue with one another is constructed.

Then, from the respective window sequences contained in the known window sequence group, the above-mentioned feature index vector is generated and input into the support vector machine. By doing this, by the support vector machine, a separation plane which separates the vector space into two spaces in such a manner that the feature vectors of disordered region and ordered region are separated can be obtained. This separation plane becomes the window level disorder classification criterion.

In this embodiment, the terms “disordered region” and “ordered region” are used in pair. The “disordered region” means a disordered region with a predetermined sequence length or more for performing appropriate classification. The “ordered region” is a region other than the disordered region. Therefore, a disordered region with a length less than the predetermined sequence length is also included in the ordered region. An ordered region may be referred to as “non-disordered region”.

When the above-mentioned feature index vector derived from the unknown window sequence group is input into the support vector machine (SVM) having the thus obtained window level disorder classification criterion as a separation plane, the probability (reliability) that the window sequence belongs to a disordered region is output as a value ranging from 0 to 1. This probability (reliability) is defined as a window level disorder index.

The output value of the support vector machine ranges from 0 to 1 as described above and is output as the probability. In general, classification is determined based on whether this output value is 0.5 or more, or less than 0.5. However, in this embodiment, this output value is directly used as a window level disorder index value indicating the probability (reliability) that each unknown window sequence belongs to a disordered region.

The subsequent 2nd step is a prediction step at the amino acid level. In this step, the following processing is carried out by focusing one amino acid residue. This focused amino acid residue is referred to as a focused residue.

In the 2nd step, first, a focused residue is linked to the window level disorder index values. At the time of proceeding to the 2nd step, the window level disorder index values have already been acquired respectively from a plurality of neighboring window sequences which are sifted by one residue with one another in the 1st step. For example, if the number of residues of the window sequence is 40, one focused residue is contained in 40 window sequences in total from when it is present at the right end of the window sequence until when it is present at the left end. Accordingly, one focused residue is linked to 40 window level disorder index values.

In this embodiment, by understanding the feature of these window level disorder index values linked to one focused residue, it is desired to find out whether the focused residue belongs to a disordered region or an ordered region. That is, it is desired to predict whether or not one focused residue belongs to a disordered region.

Therefore, in this embodiment, in the 2nd step, the distribution characteristic (distribution of reliabilities) of the 40 window level disorder index values linked to one focused residue is analyzed. Specifically, with regard to the 40 window level disorder index values, frequency distribution (distribution of reliabilities) for each of the 10 types (10 steps or ranks) of numerical value ranges is calculated and the resulting frequency distribution is normalized. Then, it is determined whether the normalized frequency distribution belongs to a disordered region or an ordered region.

Also in this case, a support vector machine having an amino acid residue level disorder classification criterion as a separation plane is used. The amino acid residue level disorder classification criterion can be acquired with a support vector machine by using previously known data. In this case, the above-mentioned frequency distribution can also be acquired from the known data group in the same manner, and vector data of these respective frequency distributions are obtained, and the vector data group is input into the support vector machine. As a result, a separation plane which separates the frequency distribution vector space into two spaces in such a manner that the data of disordered region and ordered region are separated can be obtained. This separation plane becomes the amino acid residue level disorder classification criterion.

When the above-mentioned frequency distribution vector of the focused residue of an amino acid sequence in which a disordered region is unknown is input into the support vector machine (SVM) having the thus obtained amino acid residue level disorder classification criterion as a separation plane, the probability (reliability) that the focused residue belongs to a disordered region is output as a value ranging from 0 to 1. This probability (reliability) is defined as an amino acid residue level disorder index.

The output value of the support vector machine ranges from 0 to 1 as described above and is output as the probability. Here, it is determined whether the focused residue is classified into a disordered region or an ordered region based on whether this output value is 0.5 or more, or less than 0.5.

When the result of classifying the focused residue into a disordered region is obtained, by correcting the classification result based on a predetermined rule, a region which is a disordered region among the amino acid sequence of the prediction target is determined. In this embodiment, when the length of the successive focused residues which have been so classified that they belong to a disordered region is 21 or more residues, the region is determined to be a disordered region.

While in the above-mentioned window level prediction (1st step) and the amino acid level prediction (2nd step) with the use of the support vector machine, the standard length of a disordered region was set to 40 residues, in this final determination step, the standard length of a disordered region is set to 21 residues. However, of course it does not matter that both standard lengths are the same.

The above-mentioned rule will be more specifically described. The above-mentioned rule is not particularly limited to a rule that the 20 residue length is a threshold, and another arbitrary rule can be employed. For example, a rule that the 30 or 40 residue length is a threshold can be employed. Alternatively, if there is a case where about one or two focused residues that are so classified that they belong to an ordered region are present in a predetermined residue length, but all the other residues are so classified that they belong to a disordered region, a rule can be so established that in this case, all the predetermined residue length is determined to be a disordered region.

The thus obtained result is output as a prediction result indicating a disordered region of the amino acid sequence of the prediction target. In the above description, in the 1st step and the 2nd step, learning and prediction are carried out with the support vector machine (SVM), which is a machine learning method. However, there is no particular limitation, and other learning and prediction methods can also be appropriately employed.

<More Detailed Description of Learning Function>

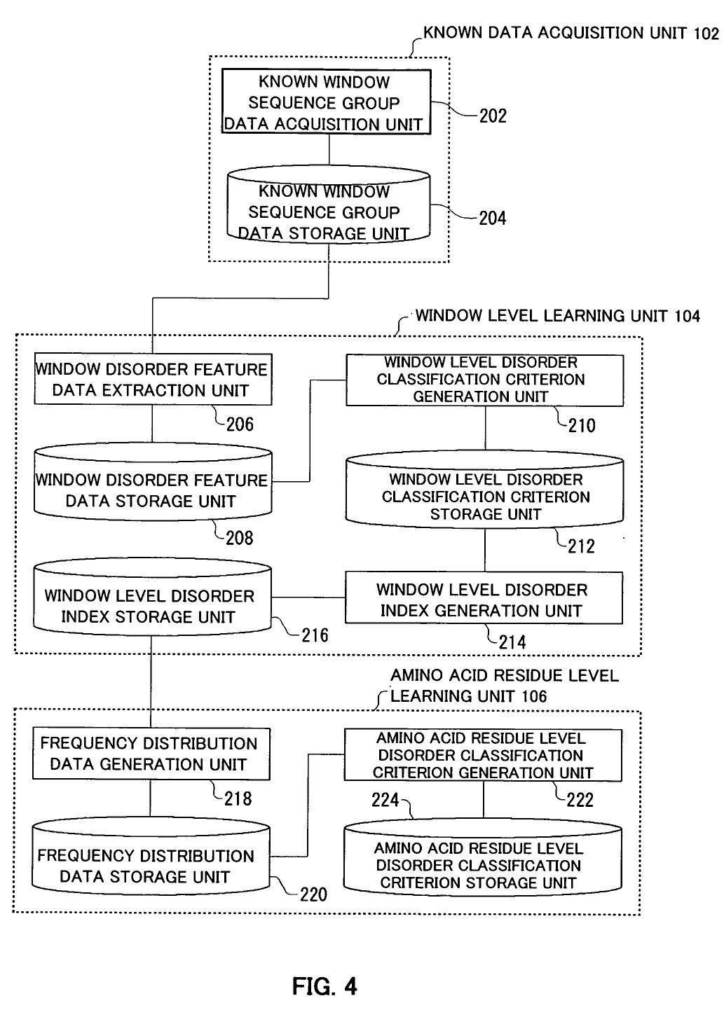

FIG. 4 shows a learning function structure in the biological information processing apparatus 100 according to an embodiment. The learning function is provided with a known data acquisition unit 102, a window level learning unit 104 and an amino acid residue level learning unit 106. This learning function is composed of a computer of the biological information processing apparatus 100 according to the embodiment and two support vector machines executed therein and realized by them.

The known data acquisition unit 102 of the biological information processing apparatus 100 includes a known window sequence group data acquisition unit 202. When receiving one amino acid sequence, the known window sequence group data acquisition unit 202 extracts window sequences with a predetermined window size from the input amino acid sequence of a polypeptide. Then, by aligning these window sequences in such a manner that they overlap one another while they are shifted by a predetermined number of residues, a known window sequence group is generated. The thus acquired known window sequence group is stored in a known window sequence group data storage unit 204.

Further, the window level learning unit 104 of the biological information processing apparatus 100 includes a window disorder feature data extraction unit 206. This window disorder feature data extraction unit 206 extracts a window disorder feature index based on the amino acid sequence of each window sequence contained in the known window sequence group and generates a feature index vector corresponding to each window sequence. The thus obtained feature index vector is stored in a window disorder feature index storage unit 208.

Further the window level learning unit 104 of the biological information processing apparatus 100 includes a window level disorder classification criterion generation unit 210. This window level disorder classification criterion generation unit 210 inputs the feature index vector into the support vector machine (SVM) and generates a window level disorder classification criterion for classifying the feature index vector. At this time, a separation plane of the support vector machine becomes the window level disorder classification criterion. The thus generated window level disorder classification criterion is stored in a window level disorder classification criterion storage unit 212.

Further, the window level learning unit 104 of the biological information processing apparatus 100 includes a window level disorder index generation unit 214. This window level disorder index generation unit 214 inputs the feature index vector into the support vector machine (SVM) having the thus generated window level disorder classification criterion as a separation plane. As a result, from the support vector machine, a window level disorder index value indicating the probability that the feature index vector belongs to a disordered region is generated. The thus generated window level disorder index value is stored in a window level disorder index value storage unit 216.

Further, the amino acid residue level learning unit 106 of the biological information processing apparatus 100 includes a frequency distribution data generation unit 218. This frequency distribution data generation unit 218 generates frequency distribution data for each focused amino acid residue using the thus obtained window level disorder index value. At this time, the frequency distribution data generation unit 218 collects all the index values of window sequences containing the focused amino acid residue at any site between the right end and the left end and calculates the occurrence frequency for each predetermined numerical value range. The thus obtained frequency distribution data are stored in a frequency distribution data storage unit 220.

Further, the amino acid residue level learning unit 106 of the biological information processing apparatus 100 includes an amino acid residue level disorder classification criterion generation unit 222. This amino acid residue level disorder classification criterion generation unit 222 inputs the thus obtained frequency distribution data into the support vector machine (SVM) and generates an amino acid residue level disorder classification criterion so as to classify the frequency distribution data into data of disordered region and data of ordered region. At this time, a separation plane of the support vector machine becomes the amino acid residue level disorder classification criterion. The thus generated amino acid residue level disorder classification criterion is stored in an amino acid residue level disorder classification criterion storage unit 224.

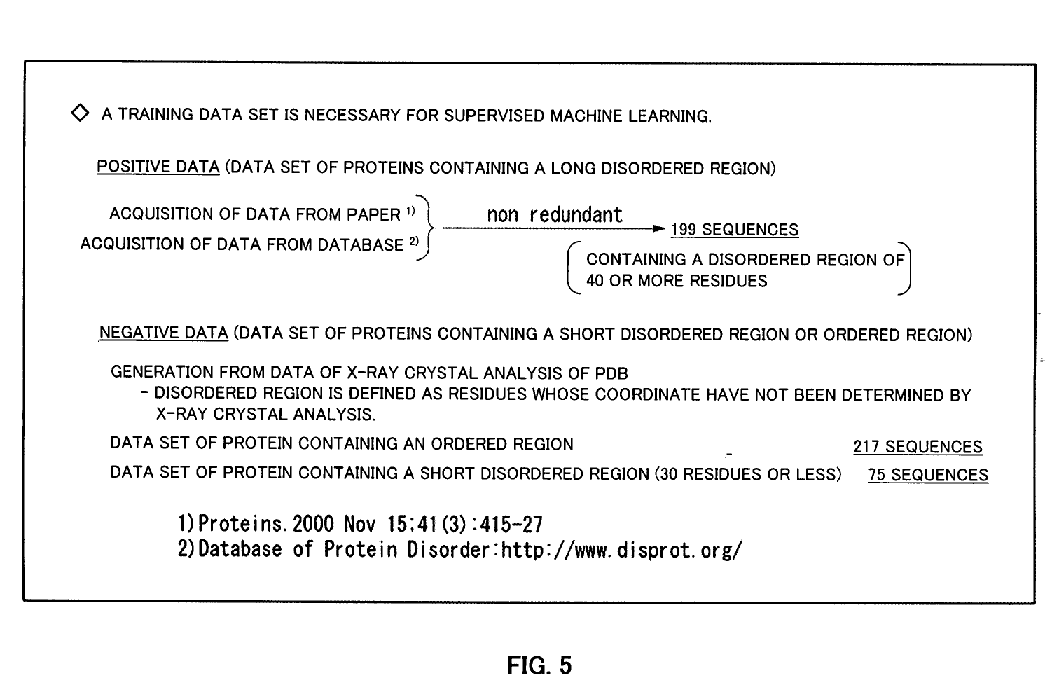

FIG. 5 is a conceptual diagram showing a general outline of a training set to be used for learning in the biological information processing apparatus 100 according to an embodiment. In general, a training data set is necessary for supervised machine learning such as the support vector machine (SVM).

Thus, in this embodiment, specifically, as positive data (a data set of protein containing a long disordered region), data acquired from the paper (Proteins, 2000, Nov. 15 ; 41 (3) : 415-27) and data acquired from the database (Database of Protein Disorder: http://www.disprot.org/) were used. When amino acid sequences containing a disordered region of 40 or more residues in a non-redundant manner were selected from these data sources, 199 sequences were obtained.

On the other hand, negative data (a data set of protein containing a short disordered region or ordered region) was created from the data of X-ray crystal analysis of PDB. Here, the disordered region is defied to be a residue whose coordinate has not been determined in the X-ray crystal analysis. Then, assuming that a protein whose X-ray crystal analysis data have been determined is a protein containing a short disordered region or ordered region, it was classified into the negative data.

As a result, as for the negative data, 217 sequences as a data set of protein ordered region, and 75 sequences as a data set of protein containing a short disordered region (30 residues or less) could be obtained. Hereafter, unless otherwise specified, learning was carried out with the use of the training set containing these positive and negative data.

In this embodiment, a window sequence in which amino acid residues which are classified into a disordered region do not successively continue to have a predetermined length (30 residues in this embodiment) is treated as a window sequence composed of an ordered region. This is due to the convenience of the selection of learning sample, and not meant to particularly limit the invention.

For example, a window sequence in which amino acid residues classified into a disordered region do not successively continue to have a predetermined length (40 residues in this embodiment) may be used as a window sequence composed of an ordered region. In this case, the window sequence composed of an ordered region includes a window sequence composed of an ordered region and a window sequence containing a short disordered region with a length of less than 40 residues.

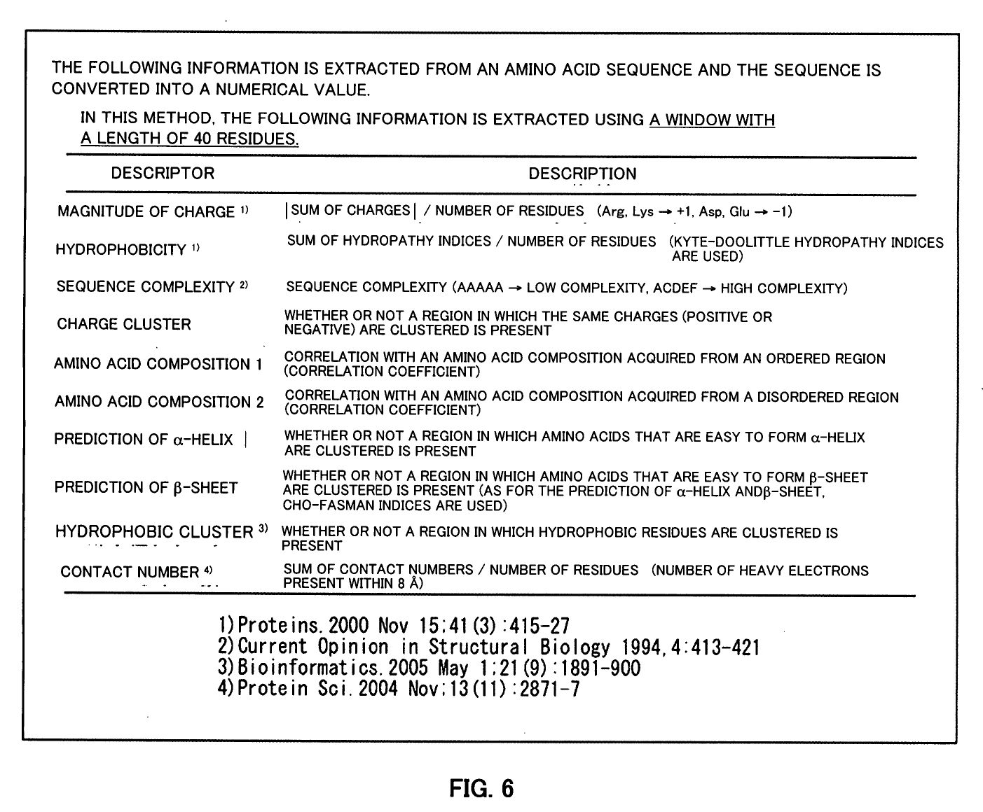

FIG. 6 is a conceptual diagram showing a general outline of feature indices extracted in the first step of the biological information processing apparatus 100 according to an embodiment. In this embodiment, the following information (biological feature indices) was extracted from the amino acid sequences in the known window sequence group and the respective amino acid sequences were converted into numerical values, whereby feature vectors were generated.

In this method, specifically, 10 types of information (biological feature indices) that have an influence on the probability that an amino acid sequence belongs to a disordered region are extracted from the window sequences with a length of 40 residues, and 10-dimensional feature vectors containing the 10 types of biological feature indices (descriptors) as factors are generated. A detailed method of acquiring these biological feature indices will be described below.

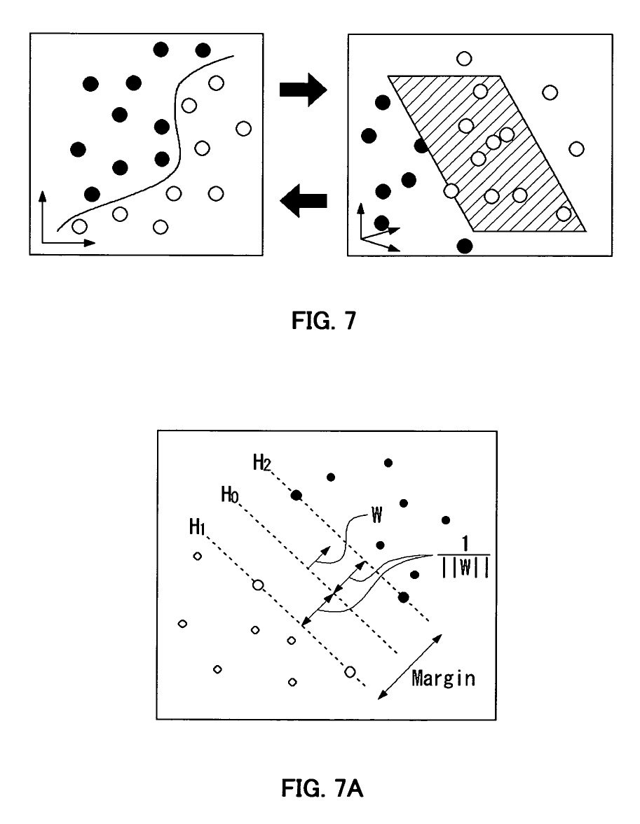

FIG. 7 is a conceptual diagram showing a general outline of a support vector machine which is provided in the biological information processing apparatus 100 according to an embodiment. In this embodiment, by using a support vector machine (SVM), which is one type of machine learning method in pattern recognition, two-class pattern recognition is carried out. This support vector machine is used either at the window level or at the amino acid residue level.

As shown in the left side of FIG. 7, if there is a case where it is difficult to separate well into two classes by a plane in an input space, as shown in the right side of FIG. 7, N pieces of learning samples are mapped in a feature space and a hyperplane may be so set that the samples can be separated well into two classes. In addition, as shown in FIG. 7A, when the plane of the input space or the hyperplane of the feature space is set it is preferably set so as to maximize the margin.

In this embodiment, the support vector machine is used in the case where a variety of classification criteria are generated. Further, the support vector machine is used for acquiring the window level disorder index value of unknown data by applying a variety of vectors to a support vector machine having a classification criterion that has already been present as a separation plane. Further, the support vector machine is also used for classifying the frequency distribution vectors of unknown data into a disordered region or an ordered region. In this case, the window level disorder index value is acquired based on the positional relationship between the separation plane and the vector data. More specifically, the window level disorder index value is acquired as a value associated with the distance between the separation plane and the vector data.

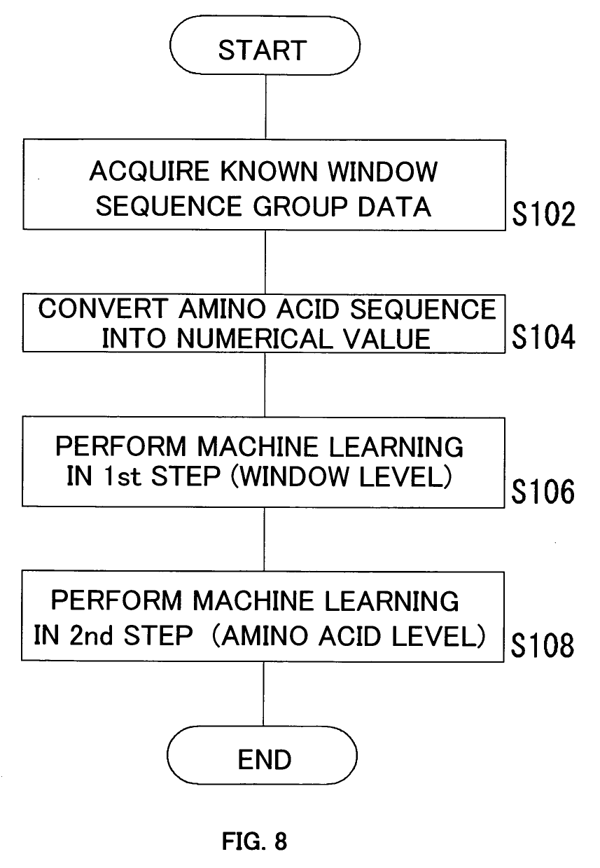

FIG. 8 is a flowchart for illustrating a flow of learning in the biological information processing apparatus 100 according to an embodiment. In this embodiment, first, known window sequence group data are acquired by the known window sequence group data acquisition unit 202 (S102). Then, by the window disorder feature data extraction unit 206, a feature index vector is generated by converting the amino acid sequence into a numerical value (S104).

Then, in the window level disorder classification criterion generation unit 210, the above-mentioned feature index vector is input into the support vector machine, the machine learning in the first step is carried out at the window level, and a window level disorder classification criterion and a window level disorder index value are generated (S106).

Further, in the amino acid residue level disorder classification criterion generation unit 222, frequency distribution data generated from the window level disorder index value by the frequency distribution data generation unit 218 are input into the support vector machine, the machine learning in the second step is carried out at the amino acid level, and an amino acid residue level disorder classification criterion is generated (S108).

<More Detailed Description of Prediction Function>

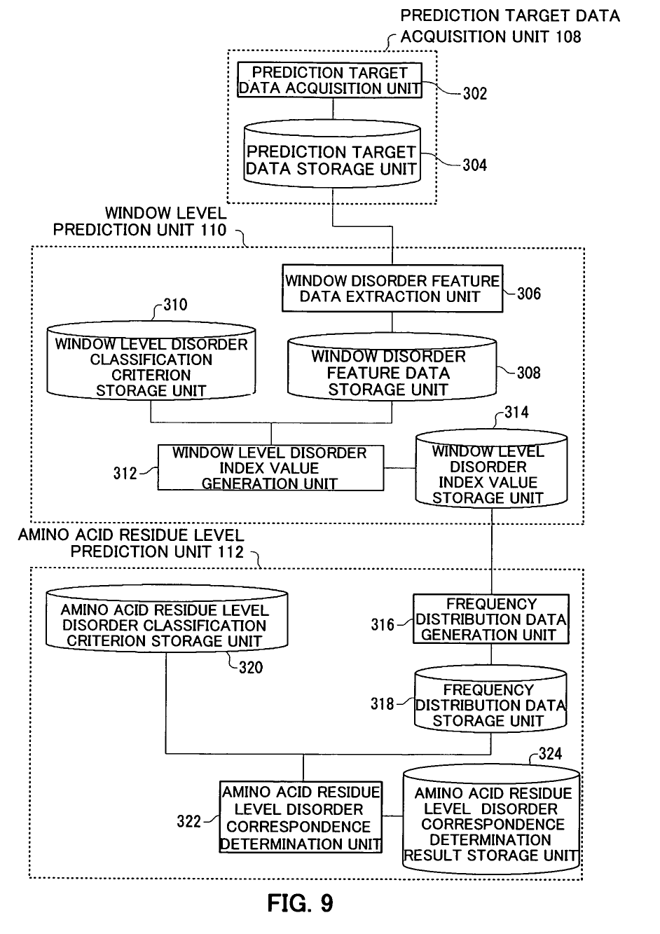

FIG. 9 shows a prediction function in the biological information processing apparatus 100 according to an embodiment. The prediction function is provided with the prediction target data acquisition unit 108, the window level prediction unit 110 and the amino acid residue level prediction unit 112. This prediction function is composed of a computer of the biological information processing apparatus 100 according to the embodiment and programs of two support vector machines executed therein and realized by them like the above-mentioned learning function.

The prediction target data acquisition unit 108 of the biological information processing apparatus 100 includes a prediction target data acquisition section 302. When receiving one amino acid sequence, the prediction target data acquisition section 302 extracts a plurality of window sequences having a predetermined window size from the input amino acid sequence of a polypeptide. Then, the prediction target data acquisition section 302 generates a prediction target window sequence group by aligning the extracted plurality of window sequences in such a manner that they overlap one another while they are shifted by a predetermined number of residues. The thus acquired prediction target window sequence group is stored in a prediction target data storage unit 304.

Further, the window level prediction unit 110 of the biological information processing apparatus 100 includes a window disorder feature data extraction unit 306. This window disorder feature data extraction unit 306 extracts a window disorder feature index based on the amino acid sequence of each window sequence contained in the prediction target window sequence group and generates a feature index vector corresponding to each window sequence. The thus obtained feature index vector is stored in a window disorder feature index storage unit 308.

Further, the window level prediction unit 110 of the biological information processing apparatus 100 includes a window level disorder classification criterion storage unit 310. This window level disorder classification criterion storage unit 310 is the same as the window level disorder classification criterion storage unit 212 and stores the window level disorder classification criterion generated by the window level disorder classification criterion generation unit 210.

Further, the window level prediction unit 110 of the biological information processing apparatus 100 includes a window level disorder index generation unit 312. This window level disorder index generation unit 312 inputs a plurality of feature index vectors into the support vector machine (SVM) having the window level disorder classification criterion as a separation plane. As a result, from the support vector machine, a window level disorder index value indicating the probability that the feature index vector belongs to a disordered region is generated. The thus generated window level disorder index value is stored in a window level disorder index value storage unit 314.

Further, the amino acid residue level prediction unit 112 of the biological information processing apparatus 100 includes a frequency distribution data generation unit 316. This frequency distribution data generation unit 316 generates frequency distribution data for each focused amino acid residue using the thus obtained window level disorder index value. At this time, the frequency distribution data generation unit 316 collects all the index values of window sequences containing the focused amino acid residue at any site between the right end and the left end and calculates the occurrence frequency for each predetermined numerical value range. The thus obtained frequency distribution data are stored in a frequency distribution data storage unit 318.

Further, the amino acid residue level prediction unit 112 of the biological information processing apparatus 100 includes an amino acid residue level disorder classification criterion storage unit 320. This amino acid residue level disorder classification criterion storage unit 320 is the same as the amino acid residue level disorder classification criterion storage unit 224 and stores the amino acid residue level disorder classification criterion generated by the amino acid residue level disorder classification criterion generation unit 222.

Further, the amino acid residue level prediction unit 112 of the biological information processing apparatus 100 includes an amino acid residue level disorder correspondence determination unit 322. This amino acid residue level disorder correspondence determination unit 322 inputs the frequency distribution data linked to the each focused amino acid residue into the support vector machine (SVM) having the amino acid residue level disorder classification criterion as a separation plane and classifies the frequency distribution data. By doing this, it is determined whether or not the respective focused amino acid residues correspond to a disordered region. The thus obtained determination result is stored in an amino acid residue level disorder correspondence determination result storage unit 324.

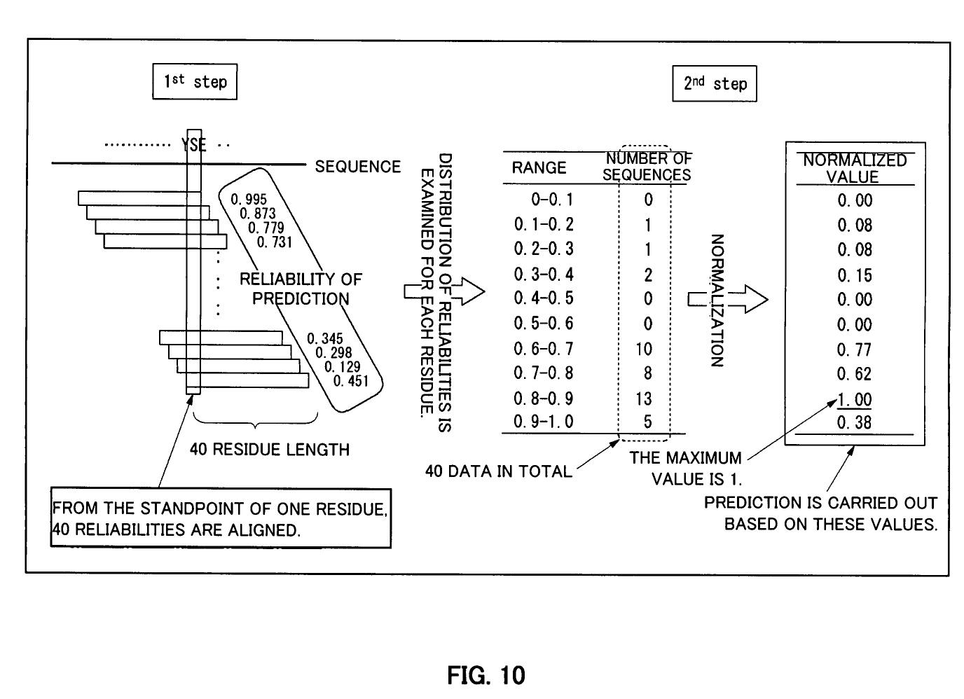

FIG. 10 is a conceptual diagram showing a general outline of a prediction method in the biological information processing apparatus 100 according to an embodiment. As shown in this drawing, in the above-mentioned window level prediction unit 110, first, prediction at the window level for an input value (amino acid sequence) in the first step is carried out.

Specifically, from the amino acid sequence of a polypeptide in which a disordered region is unknown, a plurality of window sequences with a window size of 40 amino acid residues are extracted. Then, the plurality of window sequences constitute an unknown window sequence group in which a plurality of neighboring window sequences are aligned while they are shifted by one residue with one another. In the neighboring window sequences, the amino acid sequences overlap with one another except for the amino acid residues at both terminals.

Then, from the respective window sequences contained in the unknown window sequence group, a feature index vector is generated as window disorder feature data containing a biological feature index acquired from the amino acid sequence of the window sequence.

Further, the above-mentioned feature index vector derived from the unknown window sequence group is input into the support vector machine (SVM) having the window level disorder classification criterion as a separation plane, which has been generated from the known window sequence data in advance. As a result, the probability (reliability of prediction) that the window sequence belongs to a disordered region is output as a value ranging from 0 to 1 from the support vector machine. This probability (reliability of prediction) is defined as a window level disorder index.

Subsequently, when the first step is finished, as shown in FIG. 10, prediction at the amino acid level of the second step is carried out. In this step, the following processing is carried out by focusing one amino acid residue. This focused amino acid residue is referred to as a focused residue.

In the second step, first, a focused residue is linked to the window level disorder index values. At the time of proceeding to the second step, the window level disorder index values have already been acquired respectively from a plurality of neighboring window sequences which are sifted by one residue with one another in the first step. In this embodiment, 40 window sequences are aligned. One focused residue is contained in 40 window sequences in total from when it is present at the right end of the window sequence until when it is present at the left end. Accordingly, one focused residue is linked to 40 window level disorder index values. From the standpoint of one residue, 40 reliabilities are aligned. By employing these 40 reliabilities, the distribution of reliabilities for each residue is examined.

Therefore, the profile (distribution characteristic) of the 40 window level disorder index values linked to one focused residue is analyzed. Specifically, with regard to the 40 data in total of the window level disorder index values, the profile for each of the 10 types (10 steps or ranks) of numerical value ranges is calculated and the resulting frequency distribution is normalized. These frequency distributions are normalized such that it becomes a value in the range of 0 to 1. Specifically, when a profile is created for 40 data in total, the maximum value of the occurrence frequency is 13. Accordingly, in order for the maximum value to become 1, normalization is carried out such that the value is divided by 13. Then, it is determined whether the normalized frequency distribution belongs to a disordered region or an ordered region.

That is, the profile of these normalized occurrence frequencies is input into the support vector machine (SVM) having the amino acid residue level disorder classification criterion which has already been generated as described above as a separation plane. Then, it is determined whether or not each amino acid residue is contained in a disordered region. The thus obtained determination results for the respective amino acid residues are sent to a disordered region determination unit 114.

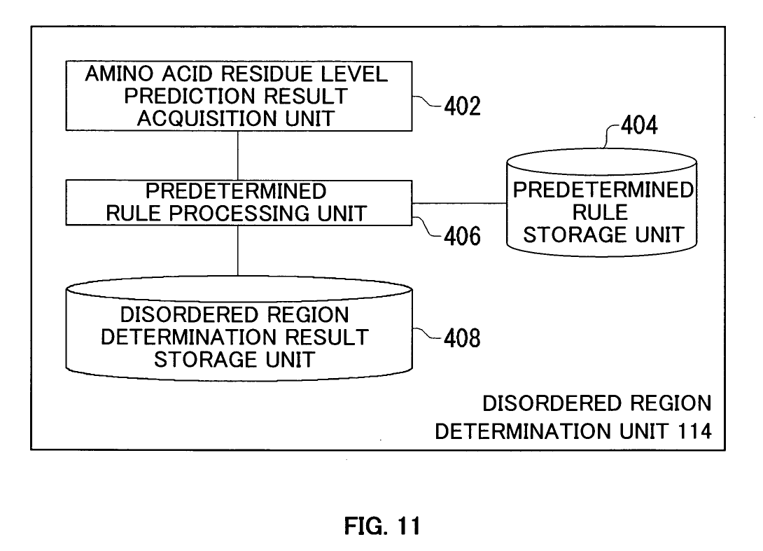

FIG. 11 is a conceptual diagram showing the disordered region determination unit 114 in the biological information processing apparatus 100 according to an embodiment. The disordered region determination unit 114 includes an amino acid residue level prediction result acquisition unit 402. This amino acid residue level prediction result acquisition unit 402 acquires data related to whether or not the respective amino acid residues belong to a disordered region generated by the amino acid residue level disorder correspondence determination unit 322.

Further, the disordered region determination unit 114 includes a predetermined rule processing unit 406. This predetermined rule processing unit 406 verifies or compares the data related to whether or not the respective amino acid residues belong to a disordered region with a predetermined rule stored in a predetermined rule storage unit 404. Then, the predetermined rule processing unit 406 determines that a region that satisfies the predetermined rule is a disordered region and a region that does not satisfy the predetermined rule is an ordered region. The thus obtained determination result is stored in a disordered region determination result storage unit 408.

Here, the predetermined rule can be arbitrarily defined. For example, the predetermined rule is defined in such a manner that, when the length of the successive focused residues which have been so classified that they belong to a disordered region is 21 or more residues, the region is determined to be a disordered region. When the length of the successive focused residues which have been so classified that they belong to a disordered region is 20 residues or less, this rule determines that the region is not a disordered region.

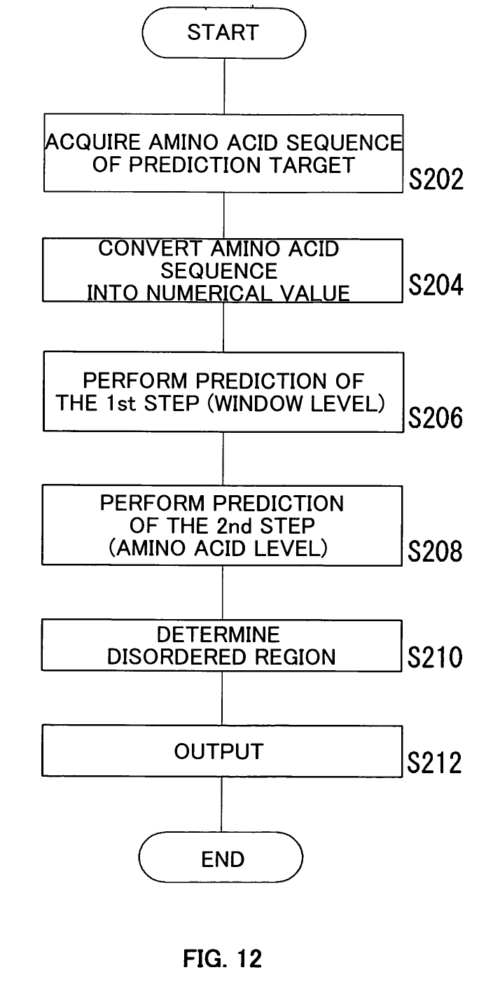

FIG. 12 is a flowchart for illustrating a flow of prediction in the biological information processing apparatus 100 according to an embodiment. In this embodiment, first, window sequence group data of a prediction target is acquired by the prediction target data acquisition section 302 (S202). Then, by the window disorder feature data extraction unit 306, the amino acid sequence is converted into a numerical value, whereby a feature index vector is generated (S204).

Then, in the window level disorder index value generation unit 312, the above-mentioned feature index vector is input into the support vector machine having the window level disorder classification criterion as a separation plane, and prediction of the first step is carried out, whereby a window level disorder index value is generated (S206).

Then, by the frequency distribution data generation unit 316, frequency distribution data of window level disorder index values related to the each amino acid residue are generated based on the window level disorder index values. Then, in the amino acid residue level disorder correspondence determination unit 322, the above-mentioned frequency distribution data are input into the support vector machine having the amino acid residue level disorder classification criterion as a separation plane, and prediction of the second step is carried out at the amino acid level, whereby an amino acid residue level disorder correspondence determination result is generated (S208).

Then, by the disordered region determination unit 114, the amino acid residue level disorder correspondence determination result is verified with the predetermined rule, whereby a disordered region determination result is obtained (S210). The thus obtained disordered region determination result is output to the outside by the output unit 116 (S212)

<Method of Acquiring Biological Feature Index>

In the above-mentioned window disorder feature data extraction units 206 and 306, as described by referring to FIG. 6, biological feature indices were acquired from the window sequence data group. Hereafter, the process for acquiring the biological feature indices will be described in more detail.

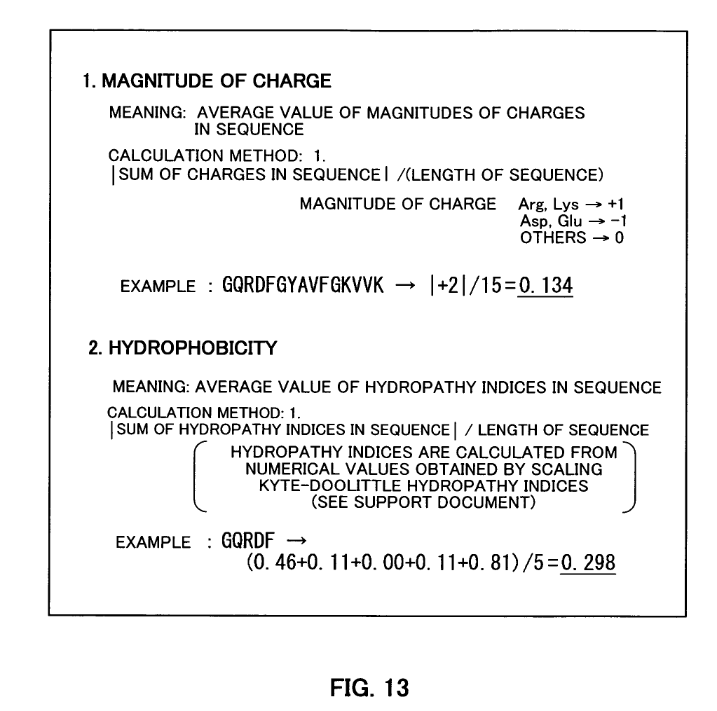

FIG. 13 is a conceptual diagram for illustrating a method of deriving feature indices (magnitude of charge and hydrophobicity). The “magnitude of charge”, which is one of the feature indices, is an index indicating an average value of magnitudes of charges in an amino acid sequence. A method of calculating the “magnitude of charge” is represented by the following calculation formula.
|sum of charges in sequence|/(length of sequence)

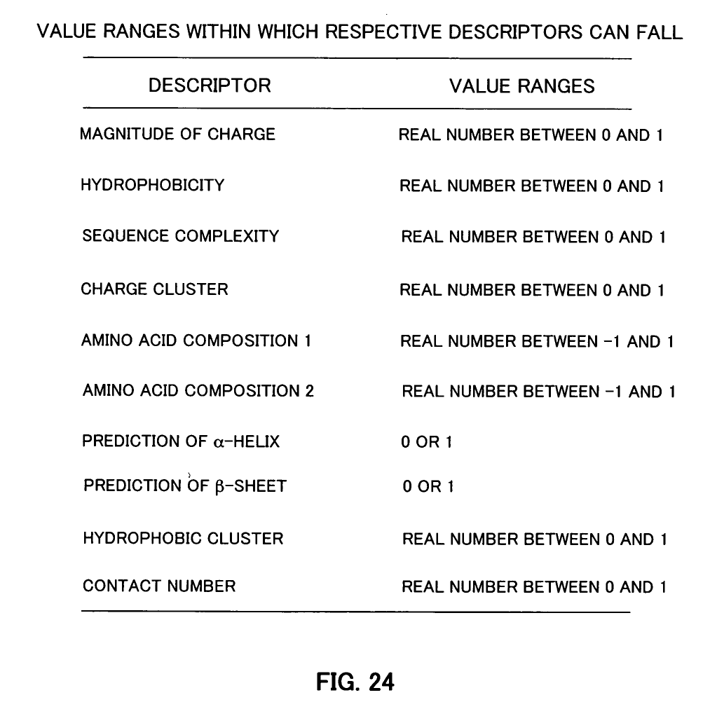

Further, the charge in a sequence can be calculated as follows (see value ranges within which respective descriptors can fall in FIG. 24).
Arg, Lys→+1,
Asp, Glu→−1
Others→0

There is a tendency that as an amino acid sequence has a larger value of this “magnitude of charge”, the probability that the amino acid sequence belongs to a disordered region is higher.

The “hydrophobicity”, which is one of the feature indices, is an index indicating an average value of hydropathy indices in an amino acid sequence. A method of calculating the “hydrophobicity” is represented by the following calculation formula.
|sum of hydropathy indices in sequence|/length of sequence

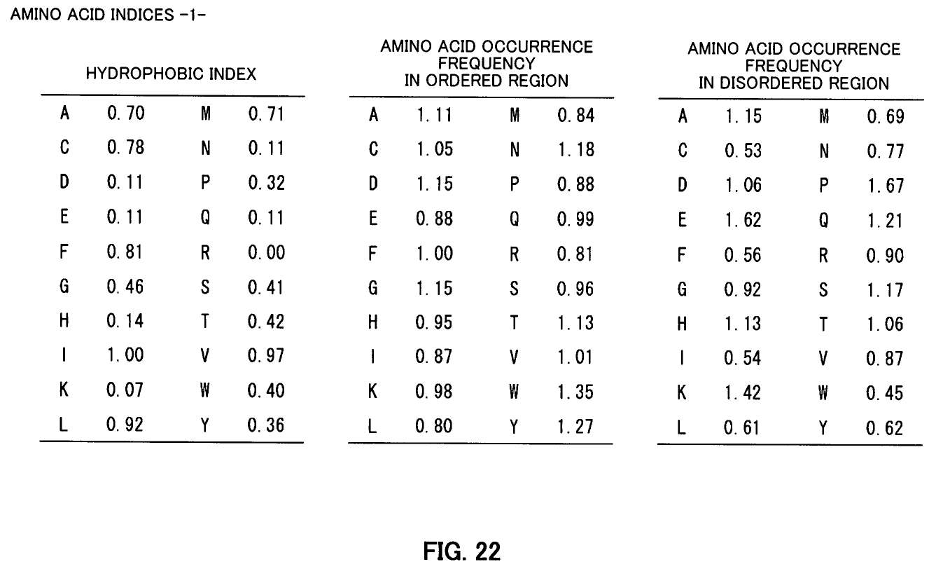

Incidentally, the hydropathy indices are calculated from numerical values obtained by scaling Kyte-Doolittle hydropathy indices (see hydrophobic index in FIG. 22) (see value ranges within which respective descriptors can fall in FIG. 24). There is a tendency that as an amino acid sequence has a smaller value of this “hydrophobicity”, the probability that the amino acid sequence belongs to a disordered region is higher.

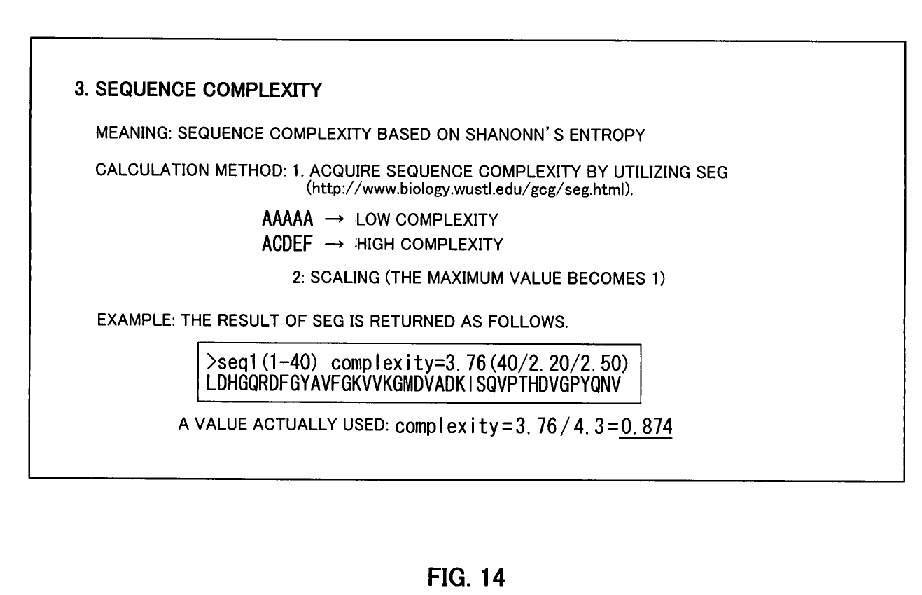

FIG. 14 is a conceptual diagram for illustrating a method of deriving a feature index (sequence complexity). The “sequence complexity”, which is one of the feature indices, is an index indicating the complexity of an amino acid sequence based on the Shannon's entropy. A process for acquiring the “sequence complexity” is as follows. (1) SEG index is acquired by utilizing SEG (http://www.biology.wustl.edu/gcg/seg.html); and (2) scaling of the SEG index is carried out in such a manner that the maximum value becomes 1 (see value ranges within which respective descriptors can fall in FIG. 24), whereby the sequence complexity is acquired. According to SEG, qualitatively, an index as shown below can be provided.
AAAAA→low complexity
ACDEF→high complexity
(A, C, D, E and F are examples of amino acid residues.)

There is a tendency that as an amino acid sequence has a smaller value of this “sequence complexity”, the probability that the amino acid sequence belongs to a disordered region is higher.

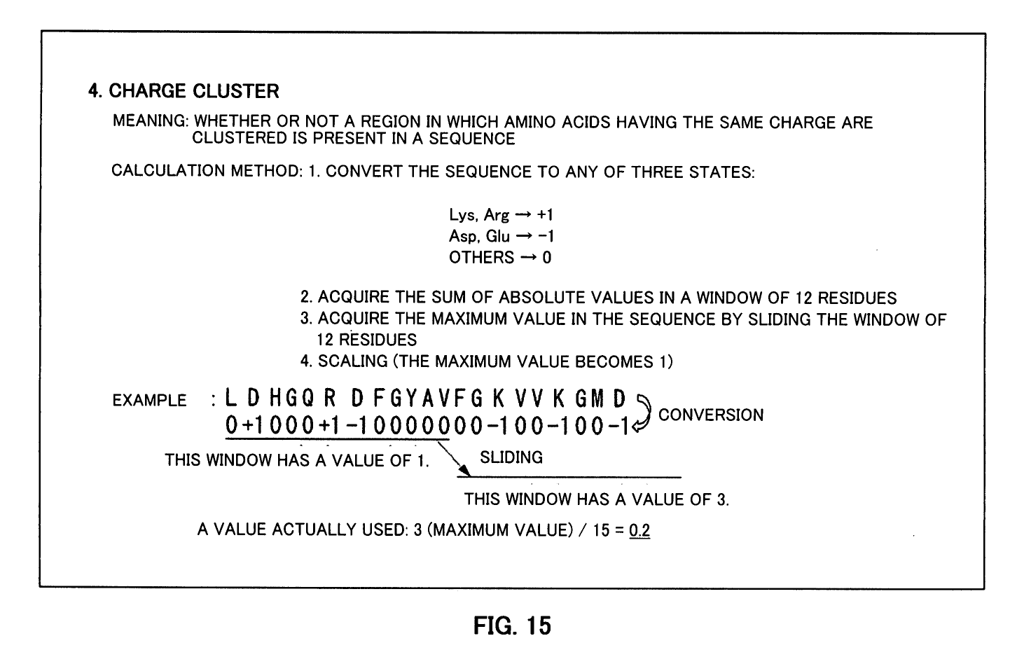

FIG. 15 is a conceptual diagram for illustrating a method of deriving a feature index (charge cluster). The “charge cluster”, which is one of the feature indices, is an index indicating whether or not a region in which amino acids having the same charge are clustered is present in an amino acid sequence. A process for acquiring the “charge cluster” is as follows.

(1) A sequence is converted into any of the following three states.

Lys, Arg→+1,
Asp, Glu→−1,
Others→0
   (2) The sum of absolute values in a window of 12 residues is acquired. (3) Sliding of window of 12 residues is carried out and the maximum value in the sequence is acquired. (4) Scaling is carried out in such a manner that the maximum value becomes 1 (see value ranges within which respective descriptors can fall in FIG. 24). In this way, the charge cluster is acquired. There is a tendency that as an amino acid sequence has a larger value of this “charge cluster”, the probability that the amino acid sequence belongs to a disordered region is higher.

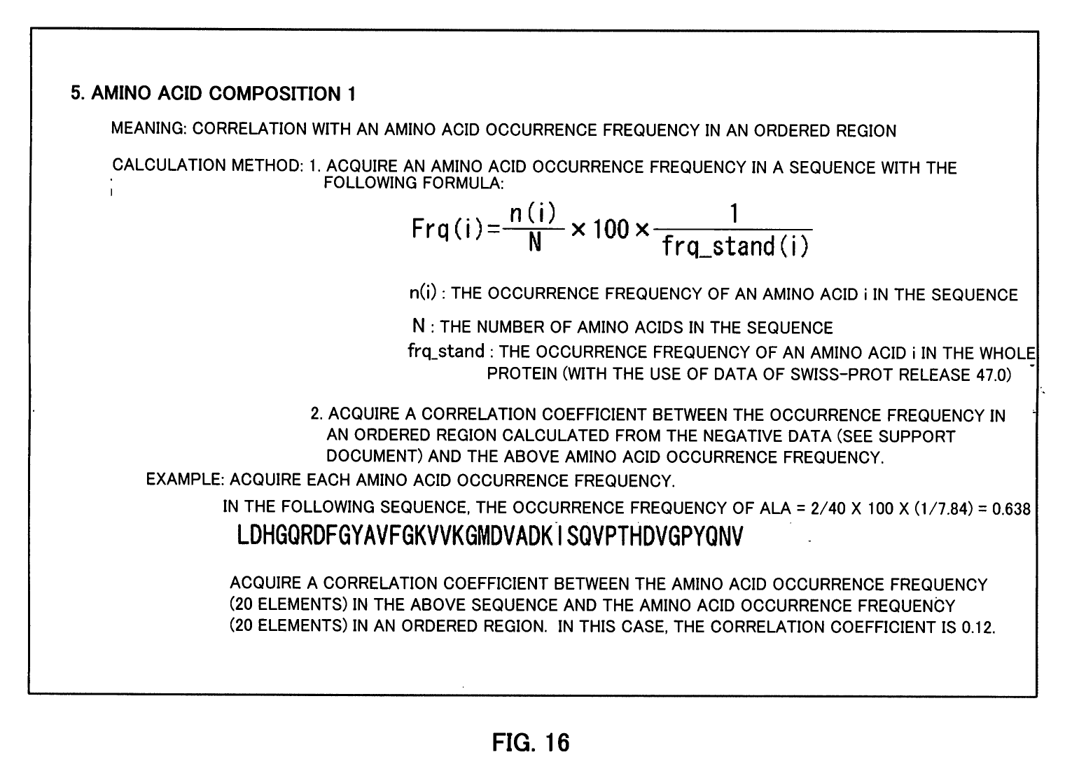

FIG. 16 is a conceptual diagram for illustrating a method of deriving a feature index (amino acid composition 1). The “amino acid composition 1”, which is one of the feature indices, is an index indicating a correlation with an amino acid occurrence frequency in an ordered region. A process for acquiring the “amino acid composition 1” is as follows.

(1) An amino acid occurrence frequency in an amino acid sequence is acquired with the following formula:
Freq(i)=n(i)/N×100×1/frq_{—}stand(i)
n(i): The occurrence frequency of an amino acid i in the sequence
N: The number of amino acids in the sequence frq_stand(i): The occurrence frequency of an amino acid i in the whole protein (with the use of data of SWISS-PROT release 47.0)
   (2) A correlation coefficient between the occurrence frequency in an ordered region calculated from the negative data (see index of amino acid occurrence frequency in ordered region in FIG. 22) and the above amino acid occurrence frequency is acquired (see value ranges within which respective descriptors can fall in FIG. 24). In this way, the “amino acid composition 1” is acquired. There is a tendency that as an amino acid sequence has a smaller value of this “amino acid composition 1”, the probability that the amino acid sequence belongs to a disordered region is higher.

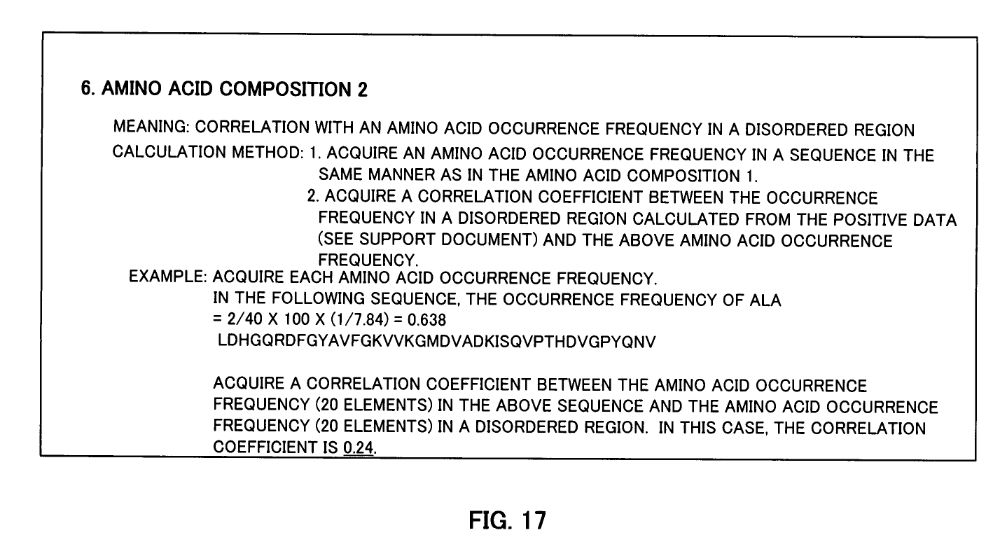

FIG. 17 is a conceptual diagram for illustrating a method of deriving a feature index (amino acid composition 2). The “amino acid composition 2”, which is one of the feature indices, is an index indicating a correlation with an amino acid occurrence frequency in a disordered region. A process for acquiring the “amino acid composition 2” is as follows. (1) An amino acid occurrence frequency in a sequence is acquired in the same manner as the case of the amino acid composition 1; and (2) a correlation coefficient between the occurrence frequency in a disordered region calculated from the positive data (see index of amino acid occurrence frequency in disordered region in FIG. 22) and the above amino acid occurrence frequency is acquired (see value ranges within which respective descriptors can fall in FIG. 24). In this way, the “amino acid composition 2” can be acquired. There is a tendency that as an amino acid sequence has a larger value of this “amino acid composition 2”, the probability that the amino acid sequence belongs to a disordered region is higher.

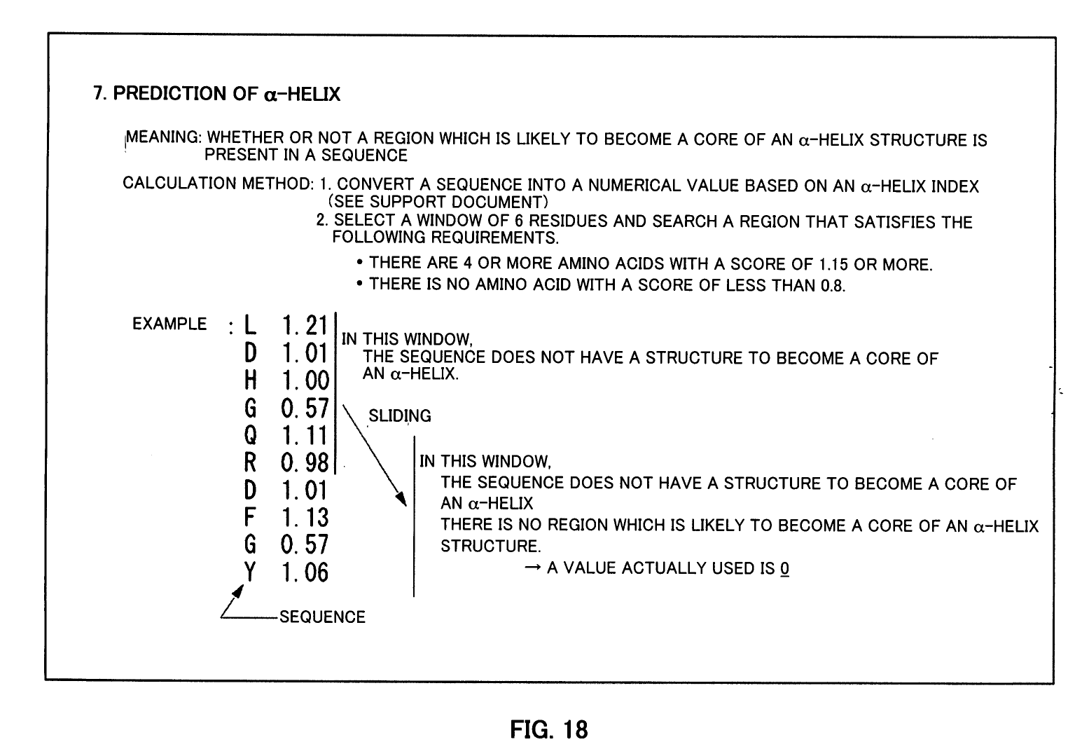

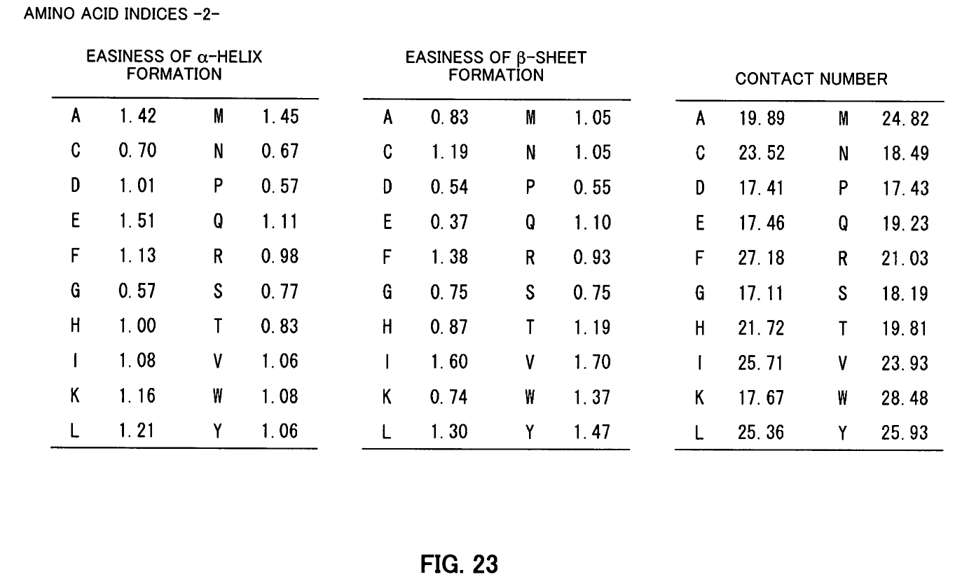

FIG. 18 is a conceptual diagram for illustrating a method of deriving a feature index (prediction of α-helix). The “prediction of α-helix”, which is one of the feature indices, is an index indicating whether or not a region which is likely to become a core of an α-helix structure is present in a sequence. A process for acquiring the “prediction of α-helix” is as follows. (1) A sequence is converted into a numerical value based on an α-helix index (index of easiness of α-helix formation in FIG. 23); and (2) a window of 6 residues is selected and a region that satisfies the following requirements is searched (see value ranges within which respective descriptors can fall in FIG. 24). In this way, the parameter of the “prediction of α-helix” can be acquired.

(Requirements)

There are 4 or more amino acids with a score of 1.15 or more. There is no amino acid with a score of less than 0.8.

There is a tendency that when an amino acid sequence does not have a region which is predicted to be an α-helix, the probability that the amino acid sequence belongs to a disordered region is high.

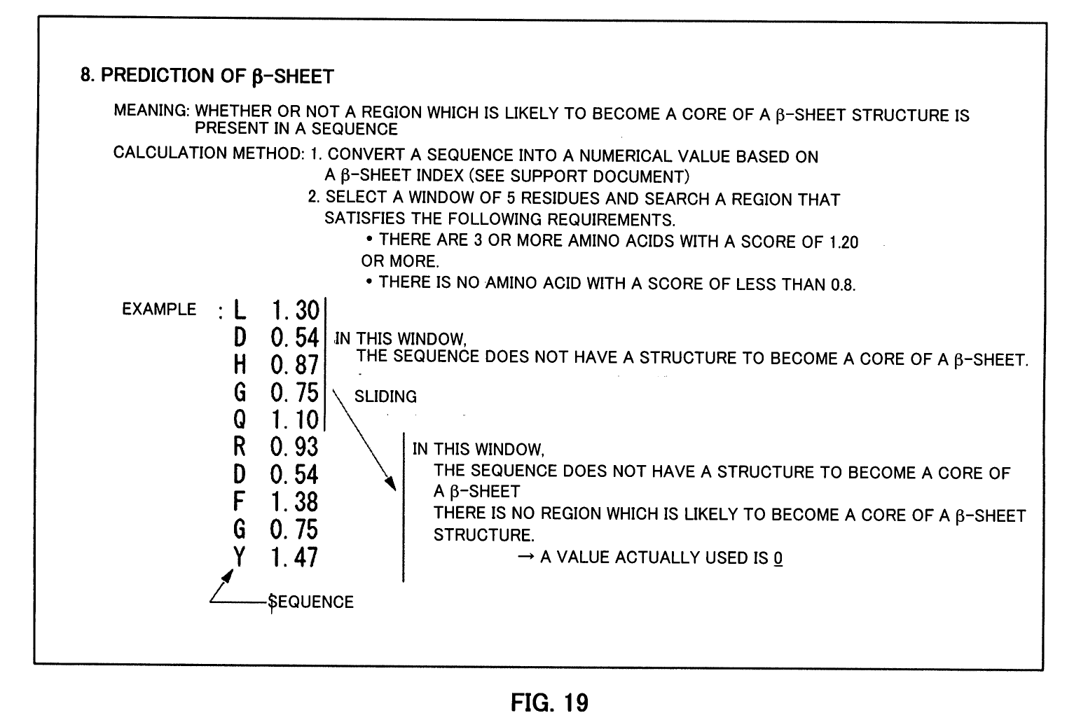

FIG. 19 is a conceptual diagram for illustrating a method of deriving a feature index (prediction of β-sheet). The “prediction of β-sheet”, which is one of the feature indices, is an index indicating whether or not a region which is likely to become a core of a β-sheet structure is present in a sequence. A process for acquiring the “prediction of β-sheet” is as follows. (1) A sequence is converted into a numerical value based on a β-sheet index (index of easiness of β-sheet formation in FIG. 23); and (2) a window of 5 residues is selected and a region that satisfies the following requirements is searched (see value ranges within which respective descriptors can fall in FIG. 24). In this way, the parameter of the “prediction of β-sheet” can be acquired.

(Requirements)

There are 3 or more amino acids with a score of 1.20 or more. There is no amino acid with a score of less than 0.8.

There is a tendency that when an amino acid sequence does not have a region which is predicted to be a β-sheet, the probability that the amino acid sequence belongs to a disordered region is higher.

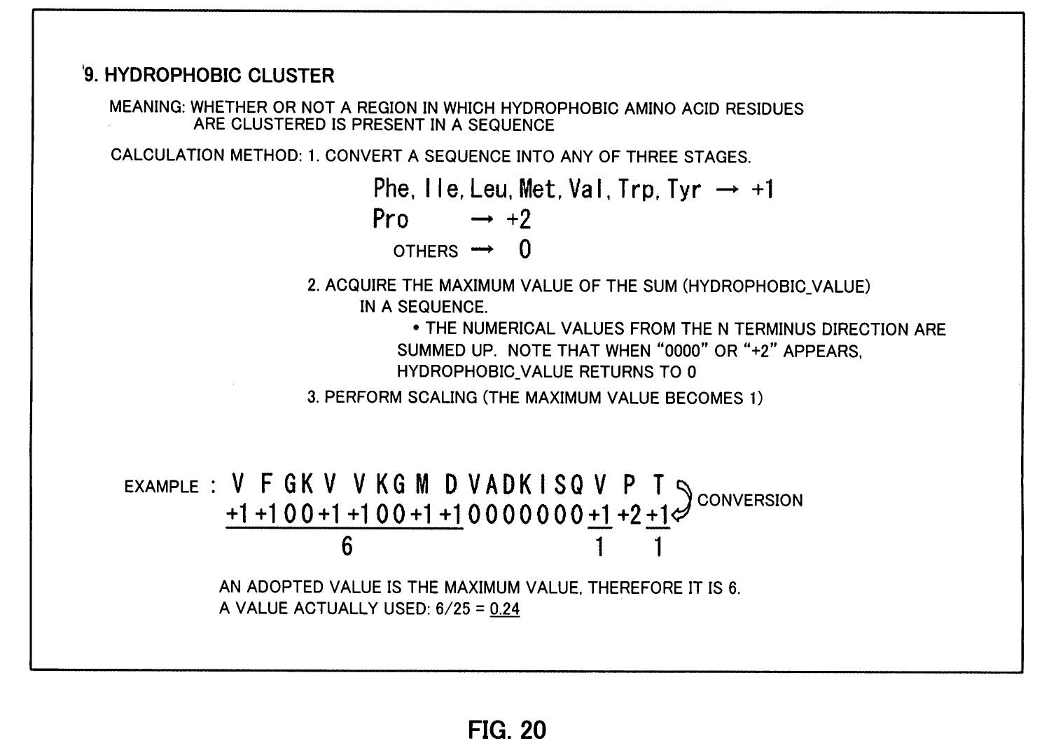

FIG. 20 is a conceptual diagram for illustrating a method of deriving a feature index (hydrophobic cluster). The “hydrophobic cluster”, which is one of the feature indices, is an index indicating whether or not a region in which hydrophobic amino acid residues are clustered is present in a sequence. A process for acquiring the “hydrophobic cluster” is as follows.

(1) A sequence is converted into any of the following three states.

Phe, Ile, Leu, Met, Val, Trp, Tyr→+1,
Pro→+2,
Others→0
   (2) The maximum value of the sum (hydrophobic_value) in a sequence is acquired by summing up the numerical values from the N terminus direction (note that when “0000” or “+2” appears, hydrophobic_value returns to 0).
   (3) Scaling is carried out in such a manner that the maximum value becomes 1 (see value ranges within which respective descriptors can fall in FIG. 24). In this way, the “hydrophobic cluster” is acquired.

There is a tendency that as an amino acid sequence has a smaller value of this “hydrophobic cluster”, the probability that the amino acid sequence belongs to a disordered region is higher.

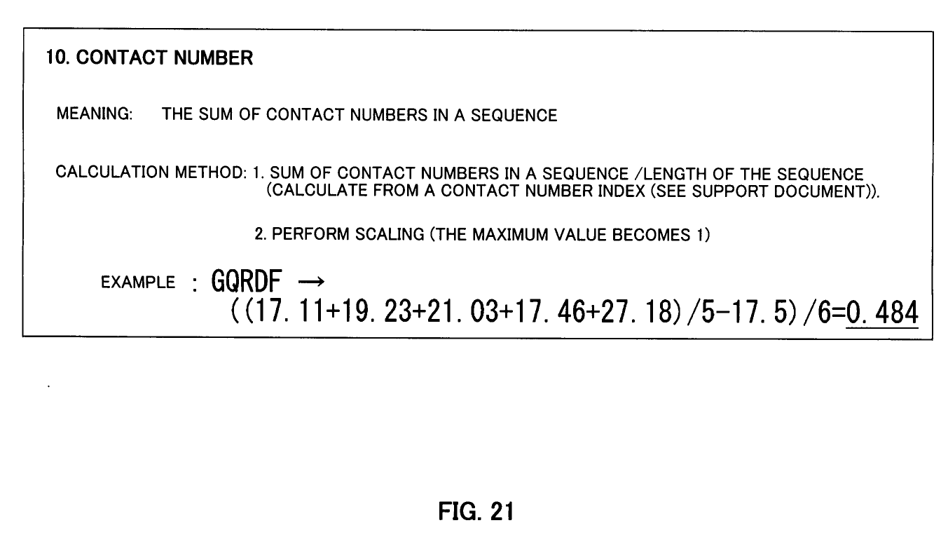

FIG. 21 is a conceptual diagram for illustrating a method of deriving a feature index (contact number). The “contact number”, which is one of the feature indices, is an index indicating the sum of contact numbers. A process for acquiring the “contact number” is as follows. (1) “The sum of contact numbers in a sequence/length of the sequence” is calculated based on the contact number index (see the contact number index in FIG. 23); and (2) scaling is carried out in such a manner that the maximum value becomes 1 (see value ranges within which respective descriptors can fall in FIG. 24). In this way, the “contact number” is acquired. There is a tendency that as an amino acid sequence has a smaller value of this “contact number”, the probability that the amino acid sequence belongs to a disordered region is higher.

Hereafter, working effects or advantages of the biological information processing apparatus 100 according to this embodiment will be described.

The biological information processing apparatus of the present invention can predict whether or not one focused amino acid residue (focused residue) is contained in a disordered region based on distribution characteristic data of window level disorder index values obtained from window sequence group composed of a plurality of window sequences which contain the focused residue in common and are shifted by a predetermined number of residues while they overlap with one another.

Therefore, with respect to one focused residue, prediction can be carried out by taking into account not only the case where the focused residue is located in the center of a window sequence, but also the case where the focused residue is located at a position outside the center of a window sequence. Accordingly, it is possible to predict whether or not the focused residue is contained in a disordered region by comprehensively taking into account an relation with a number of neighboring amino acid residues, whereby the reliability of prediction result of a disordered region in a polypeptide can be improved.

According to the present invention, the biological information processing apparatus 100 may be further provided with a disordered region determination unit 114 which specifies a region composed of an amino acid sequence, in which amino acid residues predicted to be contained in a disordered region are arranged according to a predetermined rule, as a disordered region based on the prediction result by an amino acid residue level prediction unit 112. According to this configuration, based on the prediction result of each amino acid residue, a disordered region can be specified.

Further, the biological information processing apparatus 100 may include a window disorder feature data extraction unit 206 which extracts window disorder feature data by which a disordered region is characterized from each window sequence; and a window level disorder classification criterion storage unit 212 which stores a window level disorder classification criterion which is generated based on the window disorder feature data obtained from the respective window sequences of the known window sequence groups and by which the window disorder feature data of disordered region and ordered region are classified.

According to this configuration, the biological information processing apparatus 100 stores the window level disorder classification criterion generated based on the window disorder feature data obtained from the respective window sequences of the known window sequence groups. Therefore, based on the window level disorder classification criterion, a window level disorder index value can be appropriately drawn from the window sequence derived from the amino acid sequence data of the prediction target.

Further, the biological information processing apparatus 100 may include a window level learning unit 104 which generates a window level disorder classification criterion from a known window sequence group. The window level learning unit 104 may be provided with a known window disorder feature data extraction unit 206 which extracts window disorder feature data from each of the sequences of the known window sequence group and a window level disorder classification criterion generation unit 210 which generates a window level disorder classification criterion for classifying the extracted window disorder feature data of the known window sequence group into data of disordered region and data of ordered region.

According to this configuration, the biological information processing apparatus 100 can generate a window level disorder classification criterion based on the known window sequence group whose disorder correspondence (that is, whether or not each window sequence of the group corresponds or belongs to the disordered region) is known, and can preferably predict a disordered region by using the thus generated window level disorder classification criterion.

Further, in the biological information processing apparatus 100, the above-mentioned window disorder feature data may be vector data composed of a biological feature index by which a disordered region is characterized, and the above-mentioned window level disorder classification criterion may define a separation plane provided in a space in which the vector data are located.

According to this configuration, the window disordered region feature data are prepared in the form of a vector, and as a classification criterion of a disordered region and an ordered region, a plane in a vector space is introduced. By using the vector form, the window disordered region feature data can be appropriately represented by a plurality of parameters, and a window level disorder index value can be obtained by suitably evaluating such feature data using the plane in the vector space.

Further, in the biological information processing apparatus 100, the above-mentioned biological feature index may include at least one feature index selected from the group consisting of magnitude of charge, hydrophobicity, sequence complexity, prediction value of charge cluster, correlation between known ordered region and amino acid composition, correlation between known disordered region and amino acid composition, prediction value of α-helix, prediction value of β-sheet, prediction value of hydrophobic cluster and contact number.

According to this configuration, prediction of a disordered region can be carried out by taking into account the biological feature index that has an influence on the formation of a disordered region in a protein, therefore, the reliability of prediction is improved.

Further, in the biological information processing apparatus 100, the above-mentioned window level disorder index value may be acquired based on the positional relation between the separation plane and the vector data.

According to this configuration, by using the separation plane which separates the vector data in a space as a criterion, a window level disorder index value which appropriately represents the probability of correspondence of a disordered region can be obtained.

Further, in the biological information processing apparatus 100, the above-mentioned window level prediction unit and window level learning unit 104 may include a support vector machine, and the window level disorder classification criterion may be a separation plane of the support vector machine, and the window level disorder index value may be a classification probability parameter which is output from the support vector machine by inputting the window disorder feature data into the support vector machine.

According to this configuration, an appropriate window level disorder classification criterion can be drawn from the window disorder feature data with the use of the support vector machine.

Further, in the biological information processing apparatus 100, the above-mentioned amino acid residue level prediction unit 112 may include a frequency distribution data generation unit 316 which generates frequency distribution data of a plurality of window level disorder index values obtained respectively from a plurality of window sequences containing the focused residue as distribution characteristic data of the focused residue and an amino acid residue level disorder classification criterion storage unit 320 which stores an amino acid residue level disorder classification criterion which is generated from the frequency distribution data group acquired from the known window sequence group and by which the frequency distribution data of disordered region and ordered region are classified.

According to this configuration, the frequency distribution data of a plurality of window level disorder index values obtained respectively from a plurality of window sequences containing the focused residue is used as distribution characteristic data of the focused residue, and the amino acid residue level disorder classification criterion generated based on the frequency distribution data is used. Accordingly, it is possible to predict whether or not the focused residue is contained in a disordered region by comprehensively taking into account the relation between the focused residue and a number of neighboring amino acid residues and the like, whereby the reliability of prediction result is improved.

Further, the biological information processing apparatus 100 may include an amino acid residue level learning unit 106 which generates an amino acid residue level disorder classification criterion from a known window sequence group. The amino acid residue level learning unit 106 may be provided with a known amino acid residue frequency distribution data generation unit 218 which generates a frequency distribution data group corresponding to amino acid residue group constituting a known window sequence group and an amino acid residue level disorder classification criterion generation unit 222 which generates an amino acid residue level disorder classification criterion so as to classify the frequency distribution data generated from the known window sequence group into data of disordered region and data of ordered region.

According to this configuration, the biological information processing apparatus 100 can generate an amino acid residue level disorder classification criterion based on the known window sequence group whose disorder correspondence is known (that is, whether or not each window sequence of the group corresponds or belongs to the disordered region is known) and can appropriately predict a disordered region by using the generated amino acid residue level disorder classification criterion.

Further, in the biological information processing apparatus 100, the above-mentioned frequency distribution data may be vector data composed of the occurrence frequency of the window level disorder index values for each of a plurality of predetermined numerical value ranges, and the amino acid residue level disorder classification criterion may define a separation plane provided in a space in which the vector data are located.

According to this configuration, the frequency distribution data of the window disorder index values are prepared in the form of a vector, and as a classification criterion for a disordered region and an ordered region, a plane in a vector space is introduced. By using the vector form, the frequency distribution characteristic can be appropriately represented, and a disordered region can be predicted by suitably evaluating such frequency distribution data using the plane in the vector space.

Further, in the biological information processing apparatus 100, the above-mentioned amino acid residue level prediction unit 112 and amino acid residue level learning unit 106 may include a support vector machine, and the amino acid residue level disorder classification criterion may be a separation plane of the support vector machine, and whether or not the focused residue corresponds to a disordered region may be determined based on a classification probability parameter which is output from the support vector machine by inputting the frequency distribution data into the support vector machine.

According to this configuration, it is possible to predict whether or not the focused residue corresponds to a disordered region from the frequency distribution data with the use of the support vector machine.

Further, in the biological information processing apparatus 100, the above-mentioned window size is preferably 30 or more residues, and the above-mentioned number of shifted residues is preferably one or more residues.

According to this configuration, the biological information processing apparatus 100 uses a window size with a length of 30 or more residues which is not used in the related art described in the above-mentioned related documents 1 and 2. Further, the biological information processing apparatus 100 uses a window sequence group obtained by aligning window sequences with a large window size as described above in such a manner that they are shifted by one or more residues and overlap with one another. Accordingly, a comprehensive profile (distribution characteristic of occurrence frequency) including 30 or more neighboring residues can be created for the focused residue, and by using such a profile, the reliability of prediction can be improved.

Hereinabove, the embodiment of the invention has been described by referring to the accompanying drawings, however, it is intended to be illustrative of the invention and various configurations other than those described above can also be adopted.

For example, in the above embodiment, by using a support vector machine, a variety of classification criteria are generated and application of data to a variety of classification criteria is carried out. However, a learning machine other than a support vector machine can be used. By appropriately selecting a learning machine, a sufficiently preferred classification result can be obtained.

Further, the biological information processing apparatus of the invention may be realized with a single computer or a plurality of computers located at remotes sites. The biological information processing apparatus may be connected to a network. For example, an amino acid sequence in which a disordered region is unknown may be acquired via an internet, and prediction process of the invention is carried out, and then, the prediction result may be output and returned via an internet.

As described above, the present invention has an effect of improving the reliability of prediction result of a disordered region in a polypeptide. The present invention is useful as a technique that can be applied to experimental support (X-ray crystal analysis support, provision of guideline of deletion of a region which hinders structure determination), protein function prediction, domain prediction, tertiary structure prediction and the like.

Persons of ordinary skill in the art will realize that many modifications and variations of the above embodiments may be made without departing from the novel and advantageous features of the present invention. Accordingly, all such modifications and variations are intended to be included within the scope of the appended claims. The specification and examples are only exemplary. The following claims define the true scope and spirit of the invention.

What is claimed is:

1. A biological information processing apparatus for predicting a disordered region in a polypeptide, comprising:
a prediction target data acquisition unit which acquires amino acid sequence data of a polypeptide of the prediction target;
a window level prediction unit which performs prediction of a disordered region at the level of a window sequence with a predetermined window size contained in the amino acid sequence data of the prediction target; and
an amino acid residue level prediction unit which performs prediction of a disordered region at the level of each amino acid residue contained in the amino acid sequence data of the prediction target based on the prediction result of the window level prediction unit;
wherein the window level prediction unit acquires a window level disorder index value indicating the probability that each window sequence belongs to the disordered region by comparing each of the window sequences which are shifted by a predetermined number of residues with a known window sequence group in which whether or not each window sequence corresponds to the disordered region is known; and
the amino acid residue level prediction unit sets each amino acid residue contained in the amino acid sequence data as a focused residue of the prediction target and predicts whether or not the focused residue is contained in the disordered region by acquiring distribution characteristic data of a plurality of window level disorder index values acquired respectively from the plurality of window sequences which contain the focused residue and are shifted by the predetermined number of residues, and comparing the distribution characteristic data related to the focused residue with a distribution characteristic data group acquired from the known window sequence group.

2. The biological information processing apparatus according to claim 1, further comprising a disordered region determination unit which specifies a region composed of an amino acid sequence, in which amino acid residues predicted to be contained in the disordered region are arranged according to a predetermined rule, as the disordered region based on the prediction result by the amino acid residue level prediction unit.

3. The biological information processing apparatus according to claim 1, wherein the window level prediction unit includes:
a window disorder feature data extraction unit which extracts window disorder feature data by which the disordered region is characterized from each window sequence; and
a window level disorder classification criterion storage unit which stores a window level disorder classification criterion which is generated from the window disorder feature data obtained from the respective window sequences of the known window sequence group and by which the window disorder feature data of disordered region and ordered region are classified.

4. The biological information processing apparatus according to claim 3, further comprising a window level learning unit which generates the window level disorder classification criterion from the known window sequence groups, wherein the window level learning unit includes:
a known window disorder feature data extraction unit which extracts the window disorder feature data from each of window sequences of the known window sequence group; and
a window level disorder classification criterion generation unit which generates the window level disorder classification criterion in such a manner that the extracted window disorder feature data of the window sequences of the known window sequence group are classified into data of disordered region and data of ordered region.

5. The biological information processing apparatus according to claim 3, wherein the window disorder feature data are vector data composed of a biological feature index that characterizes the disordered region, and the window level disorder classification criterion defines a separation plane provided in a space of the vector data.

6. The biological information processing apparatus according to claim 5, wherein the biological feature index includes at least one feature index selected from the group consisting of magnitude of charge, hydrophobicity, sequence complexity, prediction value of charge cluster, correlation between a known ordered region and an amino acid composition, correlation between a known disordered region and an amino acid composition, prediction value of α-helix, prediction value of β-sheet, prediction value of hydrophobic cluster and contact number.

7. The biological information processing apparatus according to claim 5, wherein the window level disorder index value is acquired based on the positional relationship between the separation plane and the vector data.

8. The biological information processing apparatus according to claim 4, wherein the window level prediction unit and the window level learning unit include a support vector machine, and the window level disorder classification criterion is a separation plane of the support vector machine, and the window level disorder index value is acquired as a classification probability parameter output from the support vector machine by inputting the window disorder feature data into the support vector machine.

9. The biological information processing apparatus according to claim 3, wherein the amino acid residue level prediction unit includes:
a frequency distribution data generation unit which generates frequency distribution data of a plurality of window level disorder index values acquired from a plurality of window sequences containing the focused residue as the distribution characteristic data of the focused residue; and
an amino acid residue level disorder classification criterion storage unit which stores an amino acid residue level disorder classification criterion which is generated from the frequency distribution data group acquired from the known window sequence group and by which the frequency distribution data of disordered region and ordered region are classified.

10. The biological information processing apparatus according to claim 9, further comprising an amino acid residue level learning unit which generates the amino acid residue level disorder classification criterion from the known window sequence group;
wherein the amino acid residue level learning unit includes:
a known amino acid residue frequency distribution data generation unit which generates frequency distribution data corresponding to the respective amino acid residues constituting the known window sequence group; and
an amino acid residue level disorder classification criterion generation unit which generates the amino acid residue level disorder classification criterion in such a manner that the frequency distribution data generated from the known window sequence group are classified into data of disordered region and data of ordered region.

11. The biological information processing apparatus according to claim 9, wherein the frequency distribution data are vector data composed of the occurrence frequency of the window level disorder index values for each of a plurality of predetermined numerical value ranges, and the amino acid residue level disorder classification criterion defines a separation plane provided in a space of the vector data.

12. The biological information processing apparatus according to claim 10, wherein the amino acid residue level prediction unit and the amino acid residue level learning unit include a support vector machine, and the amino acid residue level disorder classification criterion is a separation plane of the support vector machine, and whether or not the focused residue is present in the disordered region is acquired as a classification probability parameter output from the support vector machine by inputting the frequency distribution data into the support vector machine.

13. The biological information processing apparatus according to claim 1, wherein the window size is not less than 30 residues and the number of shifted residues is at least one.

14. A biological information processing method for predicting a disordered region in a polypeptide, comprising the steps of:
acquiring amino acid sequence data of a polypeptide of a prediction target;
performing prediction of a disordered region at the level of a window sequence with a predetermined window size contained in the amino acid sequence data of the prediction target; and
performing prediction of a disordered region at the level of each amino acid residue contained in the amino acid sequence data of the prediction target based on the prediction result by the window level prediction unit,
wherein the step of performing prediction at the window level includes the step of acquiring a window level disorder index value indicating the probability that each window sequence belongs to the disordered region by comparing each of the window sequences which are shifted by a predetermined number of residues with a known window sequence group in which whether or not each window sequence corresponds to the disordered region is known, and
the step of performing prediction at the amino acid residue level includes the step of predicting whether or not a focused residue is contained in the disordered region by setting each amino acid residue contained in the amino acid sequence data as the focused residue of the prediction target, acquiring distribution characteristic data of a plurality of window level disorder index values acquired respectively from the plurality of window sequences which contain the focused residue and are shifted by the predetermined number of residues, and comparing the distribution characteristic data related to the focused residue with a distribution characteristic data group acquired from the known window sequence group.

15. A biological information processing program for allowing a computer to predict a disordered region in a polypeptide, wherein it allows the computer to execute the steps of:
acquiring amino acid sequence data of a polypeptide of a prediction target;
performing prediction of a disordered region at the level of a window sequence with a predetermined window size contained in the amino acid sequence data of the prediction target; and
performing prediction of a disordered region at the level of each amino acid residue contained in the amino acid sequence data of the prediction target based on the prediction result by the window level prediction unit,
wherein the step of performing prediction at the window level includes the step of acquiring a window level disorder index value indicating the probability that each window sequence belongs to the disordered region by comparing each of the window sequences which are shifted by a predetermined number of residues with a known window sequence group in which whether or not each window sequence corresponds to the disordered region is known, and
the step of performing prediction at the amino acid residue level includes the step of predicting whether or not a focused residue is contained in the disordered region by setting each amino acid residue contained in the amino acid sequence data as the focused residue of the prediction target, acquiring distribution characteristic data of a plurality of window level disorder index values acquired respectively from the plurality of window sequences which contain the focused residue and are shifted by the predetermined number of residues, and comparing the distribution characteristic data related to the focused residue with a distribution characteristic data group acquired from the known window sequence group.
